(19) United States
(12) Patent Application Publication
(10) Pub. No.: US 2015/0095129 A1
(43) Pub. Date: Apr. 2, 2015

(54) LOCATION BASED CONSUMER INTERFACE FOR RETAIL ENVIRONMENT

(71) Applicant: WHEREPRO, LLC, Minnetonka, MN (US)

(72) Inventor: Mark R. Daigle, Minnetonka, MN (US)

(73) Assignee: WHEREPRO, LLC, Minnetonka, MN (US)

(21) Appl. No.: 14/244,676

(22) Filed: Apr. 3, 2014

Related U.S. Application Data
(63) Continuation of application No. 13/009,533, filed on Jan. 19, 2011, now abandoned.
Application No. 13/009,533 is a continuation-in-part of application No. 12/898,928, filed on Oct. 6, 2010, now abandoned.
(60) Provisional application No. 61/296,098, filed on Jan. 19, 2010.
(60) Provisional application No. 61/355,367, filed on Jun. 16, 2010.
(60) Provisional application No. 61/371,067, filed on Aug. 5, 2010.
(60) Provisional application No. 61/371,072, filed on Aug. 5, 2010.
(60) Provisional application No. 61/375,140, filed on Aug. 19, 2010.
(60) Provisional application No. 61/377,806, filed on Aug. 27, 2010.
(60) Provisional application No. 61/393,174, filed on Oct. 14, 2010.
(60) Provisional application No. 61/393,781, filed on Oct. 15, 2010.
(60) Provisional application No. 61/412,379, filed on Nov. 10, 2010.
(60) Provisional application No. 61/413,562, filed on Nov. 15, 2010.

(51) Int. Cl. G06Q 30/02; G06Q 20/32

(52) U.S. Cl. CPC G06Q 30/0248; G06Q 30/0226; G06Q 20/32; G06Q 30/0225
USPC 705/14.27; 705/14.47; 705/14.26

(57) ABSTRACT

A location based consumer interface for retail environments includes a plurality of data packet generators distributed around a retail store. The data packet generators include a wireless communication device and are configured to wirelessly transmit codes to mobile computing devices in the retail store. The codes are received by the mobile computing devices, and can be used to present promotional or other content to the consumer, such as content related to the consumer's current location within the store. The codes can also be used for other purposes, such as for use as part of a store rewards program. In some embodiments a vendor is charged a fee for presentation of the content to the consumer.

### CROSS REFERENCE TO RELATED APPLICATIONS

This application is a continuation of U.S. application Ser. No. 13/009,533, filed on Jan. 19, 2011, titled LOCATION BASED CONSUMER INTERFACE FOR RETAIL ENVIRONMENT; which claims priority to U.S. Provisional Application Ser. No. 61/296,098, filed on Jan. 19, 2010, titled LOCATION BASED CONSUMER INTERFACE FOR RETAIL ENVIRONMENT; and to U.S. Provisional Application Ser. No. 61/355,367, filed on Jun. 16, 2010, titled LOCATION BASED CONSUMER INTERFACE FOR RETAIL ENVIRONMENT; and to U.S. Provisional Application Ser. No. 61/371,067, filed on Aug. 5, 2010, titled LOCATION BASED CONSUMER INTERFACE FOR RETAIL ENVIRONMENT; and to U.S. Provisional Application Ser. No. 61/371,072, filed on Aug. 5, 2010, titled LOCATION BASED CONSUMER INTERFACE FOR RETAIL ENVIRONMENT; and to U.S. Provisional Application Ser. No. 61/375,140, filed on Aug. 19, 2010, titled LOCATION BASED CONSUMER INTERFACE FOR RETAIL ENVIRONMENT; and to U.S. Provisional Application Ser. No. 61/377,806, filed on Aug. 27, 2010, titled LOCATION BASED CONSUMER INTERFACE FOR RETAIL ENVIRONMENT; and to U.S. Provisional Application Ser. No. 61/393,174, filed on Oct. 14, 2010, titled LOCATION BASED CONSUMER INTERFACE FOR RETAIL ENVIRONMENT; and to U.S. Provisional Application Ser. No. 61/393,781, filed on Oct. 15, 2010, titled LOCATION BASED CONSUMER INTERFACE FOR RETAIL ENVIRONMENT; and to U.S. Provisional Application Ser. No. 61/412,379, filed on Nov. 10, 2010, titled LOCATION BASED CONSUMER INTERFACE FOR RETAIL ENVIRONMENT; and to U.S. Provisional Application Ser. No. 61/413,562, filed on Nov. 15, 2010, titled LOCATION BASED CONSUMER INTERFACE FOR RETAIL ENVIRONMENT; and is a Continuation-In-Part of U.S. patent application Ser. No. 12/898,928 filed on Oct. 6, 2010, titled LOCATION BASED CONSUMER INTERFACE FOR RETAIL ENVIRONMENT; the disclosures of which are hereby incorporated by reference in their entireties. To the extent appropriate, a claim of priority is made to each of the above-disclosed applications.

### TECHNICAL FIELD

This application relates generally to location-based technology, and more particularly to systems and methods for interfacing with a consumer in a retail environment.

### BACKGROUND

Location-based technologies such as Global Positioning Systems (GPSs) are often used for large scale outdoor activities, such as driving, boating, hiking, etc. For example, GPS technology is often used in navigation systems for providing driving directions. Although GPS technology is very useful in such large scale outdoor activities, GPS technology is not well suited to indoor smaller scale applications. In particular, GPS requires that the GPS receiver be able to detect weak satellite signals. These signals cannot usually be reliably detected within a building. Even though assisted GPS (which adds cell tower triangulation and MAC address mapping) can slightly improve the indoor precision and/or speed of operation, significant limitations remain.

A variety of mobile device applications have been developed for performing location-based operations utilizing GPS technology. Due to the inherent limitations of GPS technology, however, such applications are not typically designed for precise indoor use.

Mobile applications have also been developed for online shopping purposes. Such applications are now sometimes used by consumers when they are within a retail store, but because the application is distributed by a third party, the store retailer has no part in the process. For example, a mobile application may permit a consumer to scan a barcode or QR code while in a retail store, which then allows the consumer to obtain information from the third party company or even place an order for the product to have it shipped to the consumers home directly from the third party company—all without any interaction from the retail store itself.

There are several manners in which the retail store can interface with the consumer. One way is through personal interactions between the consumer and store personnel. The store personnel may, for example, greet the consumer upon arrival, assist the consumer in finding or selecting a product, assist the consumer in checking out, etc.

Another way that a store can interface with the consumer is through visual signs or displays. For example, many stores include external signage that identifies the store or announces a sale or other special event occurring within the store. Within the store, products are arranged in visual arrangements that attract attention to the products and may include signs or other displays that provide more information about the products. Sale signs or price discounts are also commonly displayed to the consumer, which may encourage the consumer to decide to purchase a product associated with the display, or otherwise bring attention to the products.

### SUMMARY

In general terms, this disclosure is directed to systems and methods for interfacing with a consumer, such as in a retail environment. In one possible configuration and by non-limiting example, the consumer's location within a retail store is determined by detecting a radio frequency signal emitted by a data packet generator. A data packet encoded in the radio frequency signal is received by a mobile device associated with the consumer. The data packet is used to trigger the release of content to the consumer related to the user's current location in the retail store, or for other purposes.

One aspect is a method of validating a presentation of promotional content to a consumer, the method comprising: receiving a code at a server computing device from a mobile computing device, wherein receipt of the code indicates that promotional content has been presented to the consumer, the code including at least a validation code; requesting payment from a third party to compensate for presentation of the promotional content to the user; and providing the validation code as evidence that the promotional content has been presented.

Another aspect is a method of releasing content on a mobile computing device upon the occurrence of an event, the method comprising: transferring content to a mobile computing device; transferring a first code to a mobile computing device, the first code being associated with the content; wirelessly receiving a second code with the mobile computing device; comparing at least part of the first code with at least part of the second code, and presenting the content on the mobile computing device after comparing and having found a match between at least part of the first and second codes.

A further aspect is a method of managing a consumer loyalty rewards program, the method comprising: enrolling a consumer into a loyalty rewards program for at least one store or product; receiving data at a server computing device from the consumer's mobile computing device, the data related to movement of the consumer within at least one of the stores, or otherwise near the logo of the store, or the brand of the product; and awarding points in the loyalty rewards program based at least in part upon the data.

Yet another aspect is a method of interfacing with a customer in a retail site, the method comprising: receiving a message from a mobile computing device, the message including a code obtained by the mobile computing device from all or part of a name of a wireless network; and identifying a location within the retail site associated with the code.

Another aspect is a system for identifying a location of a customer in a retail site, the system comprising: a communication device configured to communicate data across a network; at least one memory device storing code data and location data associated with the code data, and further storing data instructions; and at least one processor in data communication with the communication device and the memory device, wherein the data instructions, when executed by the processor, cause the processor to perform a method of retrieving a location identifier, the method comprising: receiving with the communication device a code from the network; using the code data, retrieving a location identifier from at least one memory device based on the code.

A further aspect is a consumer interface system comprising: a plurality of wireless communication devices physically arranged within a retail site, each of the plurality of wireless communication devices configured to generate codes and to at least occasionally transmit the codes in a wireless broadcast message to a mobile computing device; and a server computing device including a network interface for receiving digital data from a network, wherein the server receives a message from the mobile computing device including the code and retrieves from a database information associated with the location of the mobile computing device based at least in part on the code.

### BRIEF DESCRIPTION OF THE DRAWINGS

FIG. 1 is a schematic block diagram of an example consumer interface system.

FIG. 2 is a schematic block diagram of an example data packet generator of the consumer interface system, shown in FIG. 1.

FIG. 3 is a schematic block diagram illustrating an architecture of an example mobile computing device of the consumer interface system shown in FIG. 1.

FIG. 4 is a flow chart illustrating an example method of operating a consumer interface system, such as the consumer interface system shown in FIG. 1.

FIG. 5 is a flow chart illustrating an example method of operating a consumer interface system within the constraints of limited network access and required timeliness of content delivery, such as the consumer interface system shown in FIG. 1.

FIG. 6 is a flow chart illustrating an example method of adding token-based wireless beacons to a facility and selling application access rights.

FIG. 7A is a first portion of a flow chart illustrating an example user interface of a software application operating on a mobile computing device.

FIG. 7B is a second portion of a flow chart illustrating an example user interface of a software application operating on a mobile computing device.

FIG. 8 is a schematic block diagram of an example code generated by a data packet generator.

FIG. 9 is a schematic block diagram illustrating an exemplary method of operating the consumer interface system of FIG. 1.

FIG. 10 is a schematic block diagram illustrating an exemplary method of operating the consumer interface system of FIG. 1.

FIG. 11 is a schematic block diagram illustrating an exemplary method of operating the consumer interface system of FIG. 1.

FIG. 12 is a schematic block diagram illustrating an exemplary method of operating the consumer interface system of FIG. 1.

FIG. 13 is a chart illustrating a variety of exemplary software applications available for a consumer's mobile computing device.

FIG. 14 is a diagram illustrating a data packet generator connected to a product display, and a mobile computing device located within the broadcast range of the data packet generator.

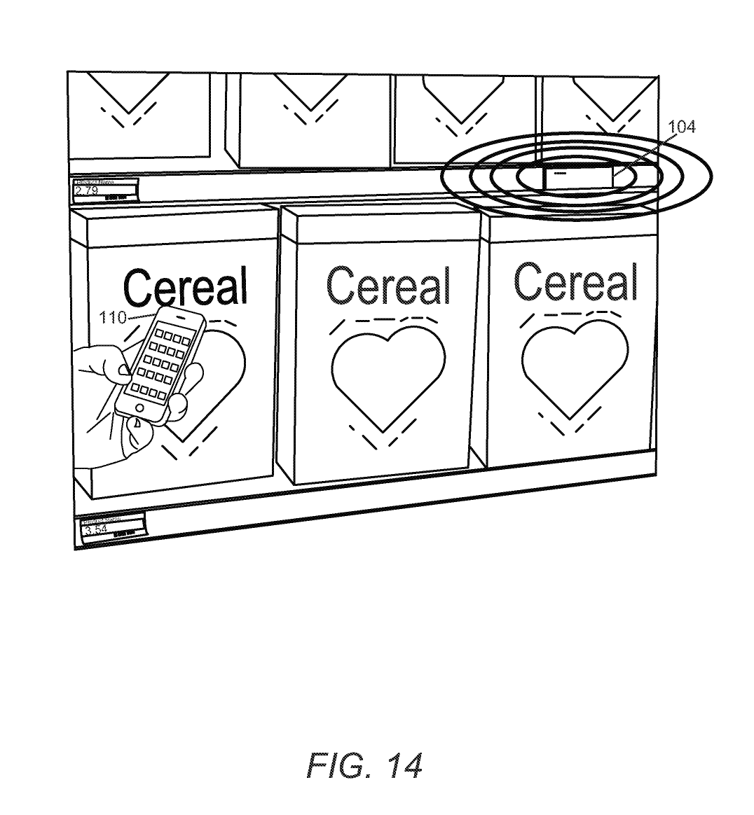

FIG. 15 is a diagram illustrating the display of content on the mobile computing device after receiving a data packet from the data packet generator shown in FIG. 14.

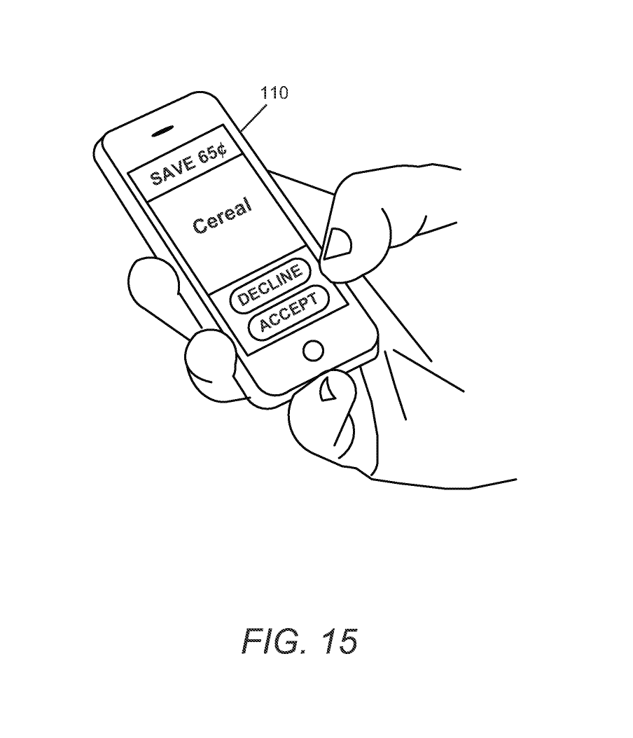

FIG. 16 is a perspective view of an example data packet generator.

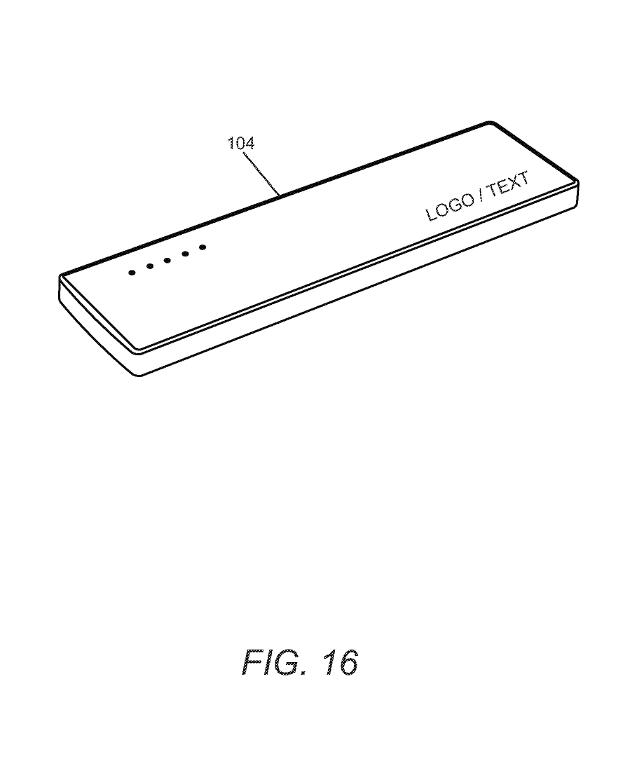

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

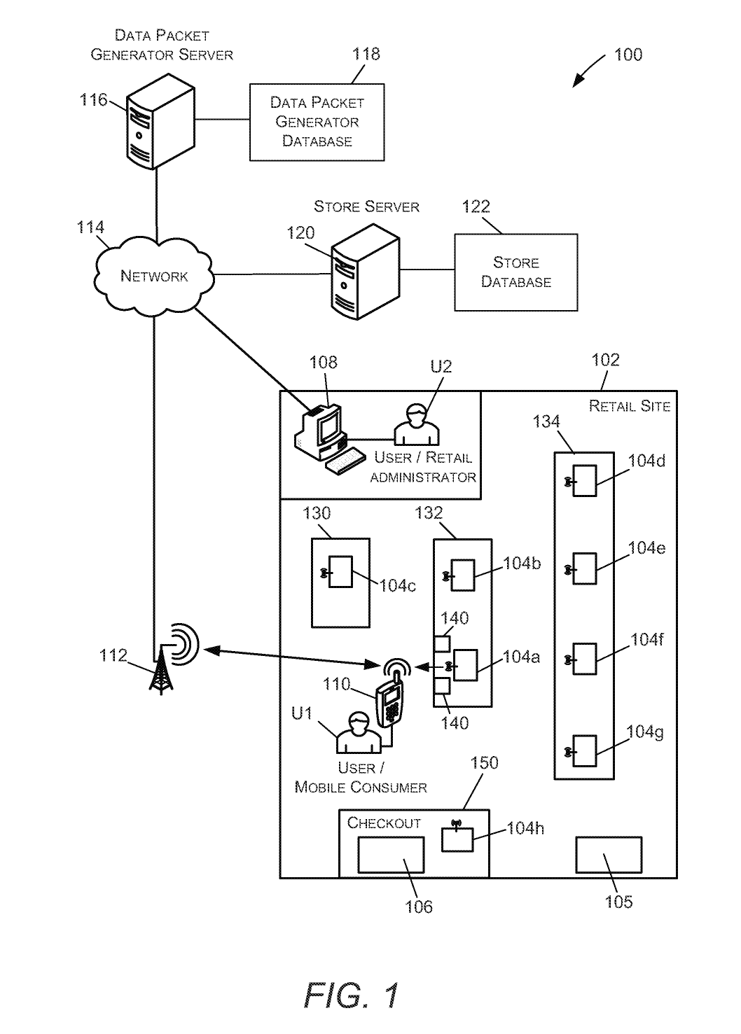

FIG. 1 is a schematic block diagram of an example consumer interface system 100. In this example, consumer interface system 100 includes retail site 102, data packet generators 104, interactive sign 105, cash register 106, computing device 108, mobile computing device 110, base station 112, network 114, data packet generator server 116, data packet generator database 118, store server 120, and store database 122. In this example, the mobile computing device 110 is operated by a mobile consumer U1, and computing device 108 is operated by a retail administrator U2. Retail site includes, for example, product displays 130, 132, and 134 including products 140, and checkout counter 150 including cash register 106.

Retail site 102 is one example of a possible location for implementing aspects of the consumer interface system 100. A retail site is, for example, a physical location where goods and services are sold or leased, or otherwise promoted. An example of a retail site is a department store. Other examples of retail sites include a retail store, a boutique, a kiosk, a booth, a table, or a stand. Another example of a retail site includes a mall or other collection of retail stores, boutiques, kiosks, booths, tables, etc. In some embodiments a retail site includes one or more buildings (such as including walls, floors, and ceilings defining the interior space of the retail site). In some embodiments a retail site includes not only a building or other structure, but also the space surrounding the building or structure, such as a hallway, walkway, sidewalk, parking lot, roadway, and land outside of the building or store. Although various aspects of the present disclosure are described with reference to an example implementation in a retail site, it is recognized that other implementations of aspects of the present disclosure are also possible. The retail site implementation is provided as just one example of the many possible implementations. Several additional examples of possible sites include an art museum, a sports stadium, a transit station, and a college campus. Additional examples of possible sites include buildings. Examples of buildings in which aspects of the present disclosure can be utilized include agricultural buildings, commercial buildings, residential buildings, educational buildings, governmental buildings, industrial buildings, military buildings, parking and storage buildings, religious or not-for-profit buildings, transit buildings, and other buildings. Examples of an agricultural building includes a barn, chicken house, green house, silo, stable, storm cellar, shed, wind mill, and a water mill. Examples of a commercial building include a bank, bar, casino, coffee house, convention center, gas station, hotel, market, nightclub, office building, restaurant, skyscraper, shop, retail store, shopping mall, supermarket, and a warehouse. Examples of a residential building include an apartment, condominium, dormitory, duplex, house, and a nursing home. Examples of an educational building include a college, gymnasium, student union, school, library, museum, theater, concert hall, cinema, and a university. Examples of a governmental building include a capitol, city hall, consulate, courthouse, embassy, first station, palace, parliament, police station, post office, and a prison. Examples of an industrial building include a brewery, factory, mining, power plant, refinery, mill and an oil rig. Examples of a military building include a barracks, bunker, castle, fort, and a tower. Examples of a parking and storage building include a boathouse, carport, garage, hangar, shed, and a warehouse. Examples of a religious or not-for profit building includes a church, cathedral, mosque, monastery, pyramid, shrine, and a temple. Examples of a transit building include a airport, bus station, ferry slip, metro, and a train station. Examples of other buildings include a bathhouse, hospital, stadium, and a marina.

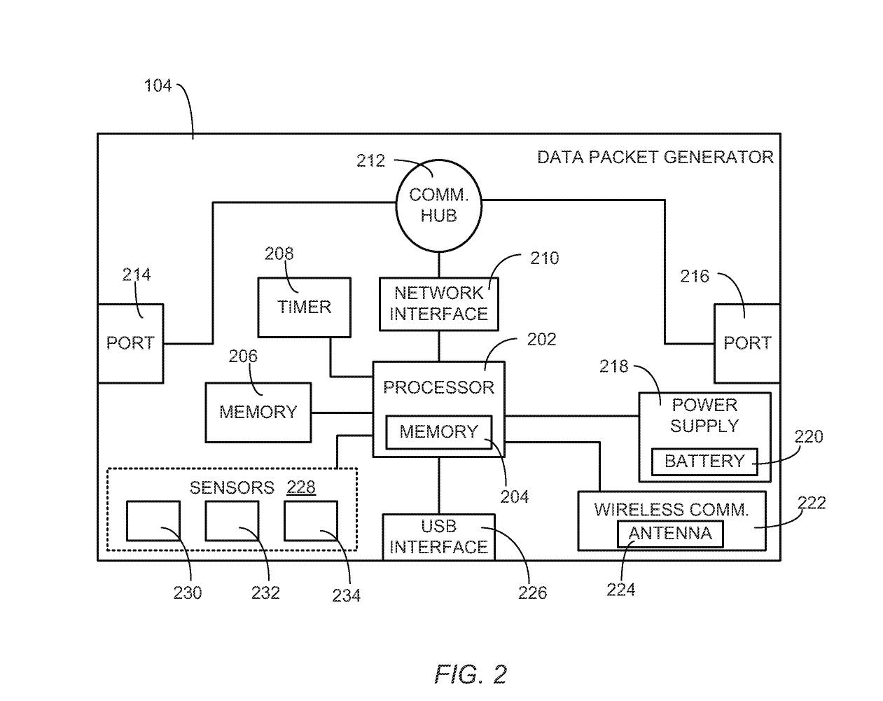

In the illustrated example, retail site 102 includes at least one data packet generator 104, and in some embodiments includes a plurality of data packet generators 104a-h. An example of data packet generator 104 is described in more detail herein with reference to FIG. 2. In an example embodiment, data packet generators 104 generate codes and periodically transmit the codes using radio frequency signals. In some embodiments the codes change occasionally, or periodically (e.g., once per minute, once per fifteen minutes, etc.).

In some embodiments, codes are transmitted by data packet generators 104 as a network name. An example of a network name is a service set identifier (SSID), which is typically used to identify a wireless network access point in a communication network conforming to the IEEE 802.11 family of protocols. In some embodiments, however, the data packet generators 104 do not allow clients to join a network and are not wireless access points. In some embodiments, the code that is transmitted is not actually a network name, but is transmitted as if it were the network name according to a network protocol (such as one of the 802.11 protocols). Alternatively, the code is transmitted as if it were another aspect of a network, such as the Media Access Control (MAC) address, Received Signal Strength Indication (RSSI), network mode, channel, security, or data transfer rate(s). Near Field Communication methods of data transfer can also be included in some embodiments.

In some embodiments, the code is included in a beacon frame, such as according to the 802.11 protocol. An example of a beacon frame includes a MAC header, frame body, and frame check sequence (FCS).

In some embodiments, the code is included in a message that is broadcast from data packet generator 104 without requiring receipt of any signal or message from mobile computing device 110, such as a synchronization signal or a request message.

Codes generated by the data packet generator 104 can take a variety of different forms, such as a numerical code, a binary code, or an alphanumeric code. In some embodiments the codes are in a range from about 2 to about 100 characters long. In another possible embodiment, the codes are about 7 characters long. In some embodiments the code is 7, 14, 21, 28, or 32 characters long. In some embodiments the code is encrypted and/or compressed when transmitted, and must be decrypted and/or decompressed to obtain the complete code. This can be performed by either mobile computing device 110 or a server, such as data packet generator server 116.

In some embodiments, data packets generated by data packet generator 104 are in the form of a message that conforms to a data communication protocol. For example, in some embodiments the message includes a header and a body. In some embodiments the code is included within the body.

In some embodiments the data packet generators 104 are synchronized together, such as through a mesh network. Additional details of example data packet generators, codes, and mesh networks are described in U.S. Ser. No. 12/544,798, U.S. Publication No. 2010/0046553, titled Data Packet Generator For Generating Passcodes, filed on Aug. 20, 2009.

In some embodiments the data packet generators do not change codes and instead are used to improve the precision of existing assisted global positioning systems such as MAC address mapping.

In addition to data packet generators 104, retail site 102 also includes cash register 106, computing device 108, product displays 130, 132, and 134 including products 140, and checkout counter 150, in some embodiments.

Some embodiments include one or more interactive signs 105. Interactive signs can be, for example, a digital display device coupled to a computing device. In some embodiments the computing device is connected to network 114, such as to receive content and instructions from store server 120. Interactive signs 105 are described in more detail herein.

Cash register 106 is a computing device that typically stores money and may also be configured to process electronic payments, such as credit card payments, from consumer U1. An employee (not shown) of retail site 102 typically operates the cash register, although in some embodiments cash register 106 is a self-service checkout device configured to interact directly with the consumer. Cash register 106 is typically located at a checkout counter 150. This is alternatively referred to as point of sale technology. Point of sale technology can also be incorporated into the mobile computing device 110.

Although not specifically illustrated in FIG. 1, it is recognized that retail site 102 often includes a local area network, which is coupled to network 114. In some embodiments, cash register 106 and computing device 108 are both coupled to the local area network, and can communicate with each other or with network 114 through the local area network. Some embodiments utilize a picocell or femptocell to boost network 114 communications.

Computing device 108 is, for example, a computing device located within retail site 102 that is operated by an owner or employee of retail site 102. For example, in some embodiments the retail administrator U2 uses computing device 108 to set prices on products 140, or to define specials, coupons, or other incentives that are available to consumer U1. In some embodiments retail administrator U2 defines messages, advertisements, or other visual displays with computing device 108, which are subsequently provided to user U1 through consumer interface system 100. In some embodiments, retail administrator U2 utilizes computing device 108 to interact with store server 120 and store database 122, or with data packet generator server 116 and data packet generator database 118.

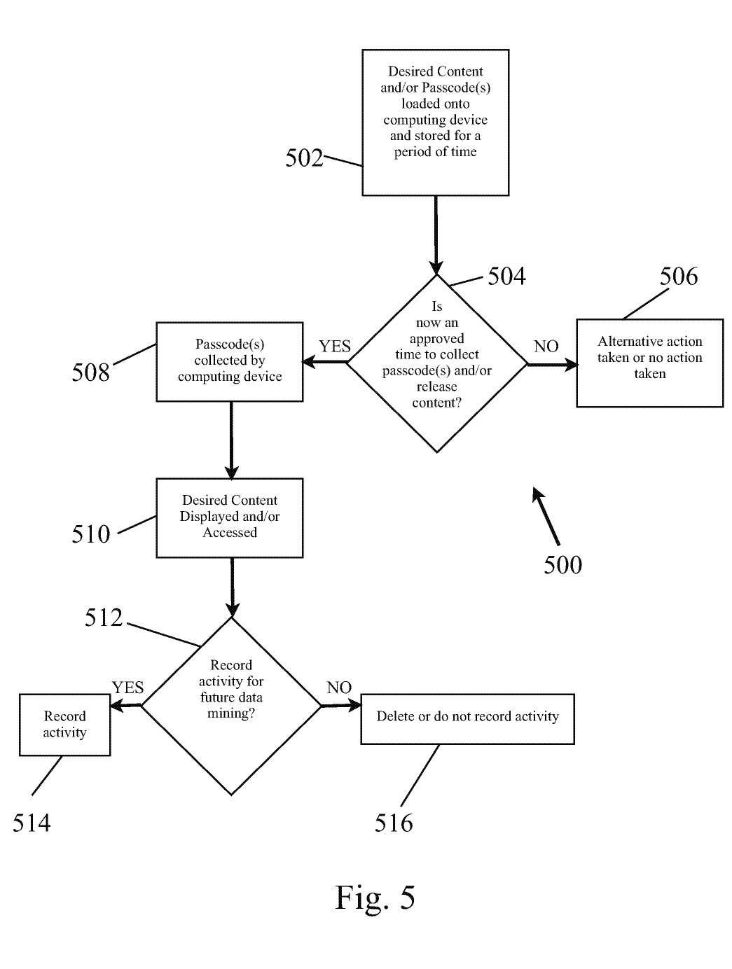

Although computing device 108 is illustrated as being located within retail site 102, in other embodiments computing device 108 is at another location outside of retail site 102. In some embodiments computing device 108 and cash register 106 are the same device. In another possible embodiment, any one or more of computing device 108, store server 120, and data packet generator server 116 operate on a single computing device, which can be located at or outside of retail site 102. In yet another possible embodiment, mobile computing device 110 acts as a permanent or temporary repository for information typically housed in computing device 108 and/or store server 120, and/or data packet generator server 116. Information repository features are described in more detail herein with reference to FIG. 5.

Products 140 within retail site 102 are typically displayed on product displays, such as product displays 130, 132, and 134. In some embodiments, data packet generators 104 are mounted to or otherwise connected to product displays 130, 132, and 134. However, in other embodiments the data packet generators are connected to other parts of retail site 102, such as being mounted to a ceiling, wall, floor, or other object (e.g., table, counter, shelf, sign, box, etc.) in retail site 102, or being physically integrated within one or more of the ceiling, wall, floor, or other object. The underside of a shelf can be a convenient place for data packet generators 104, or portions of data packet generators 104, to be installed, especially if batteries are too big to place elsewhere.

When data packet generators 104 are installed within retail site 102, they are typically installed in known locations. The known locations are then stored in data packet generator database 118 and/or store database 122 and associated with each respective data packet generator 104. For example, data packet generator 104a is known to be located toward the end of product display 132. In another example, data packet generator 104a is known to be located near products 140. In another example, data packet generator 104a is known to be located at a particular location with respect to the building (e.g., 10 feet from the west wall and 8 feet from the south wall), or with respect to the earth (e.g., at a particular latitude and longitude). In some embodiments a location is determined with a planogram or planogram map. In some embodiments the planogram is geospatially aligned. In some embodiments, locations are tied to a computer-aided facility management system. In some embodiments, a location is the location of a product. Other locations are used in other embodiments. If the data packet generators 104 are intentionally or unintentionally moved from those locations, the locations can be subsequently updated in the database.

To permit locations to be easily updated, some embodiments allow retail administrator U2 to update location data in data packet generator database 118 whenever it changes. For example, if a new product is placed in the location depicted for product 140, the location of data packet generator 104a can be updated by user U2 through computing device 108 to identify the location of data packet generator 104a as being near to the new product. Similarly, if product displays are rearranged within retail site 102, the locations of data packet generators 104 can be updated accordingly. In another possible embodiment, the data packet generators can communicate with one another to automatically identify their locations and can communicate through network 114 to data packet generator server 116 to update the respective location information stored in data packet generator database 118. For example, a mesh network is used in some embodiments. A mesh network can help to define neighboring devices, among other things.

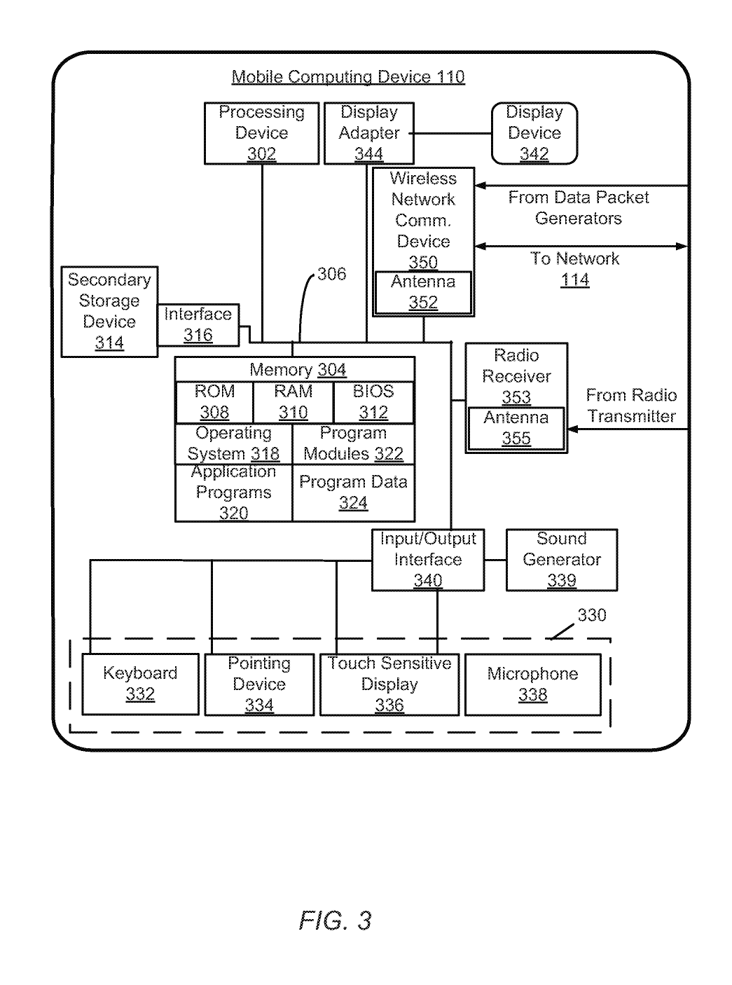

Consumer interface system 100 interacts with a consumer U1 through a mobile computing device 110. An example of a mobile computing device 110 is a smartphone. Mobile computing device 110 is described in more detail herein with reference to FIG. 3.

Mobile computing device 110 is configured for data communication with network 114, which allows it to communicate with network connected devices, such as data packet generator server 116 and store server 120. In some embodiments, mobile computing device 110 communicates with network 114 through a base station 112, such as including a cell tower. Other communication systems are used in other embodiments to link mobile computing device 110 with network 114. Although configured to communicate with network 114, the mobile computing device 110 may, at times, be unable to communicate with network 114.

In some cases, mobile computing device 110 has interrupted data communication with network 114, such as when the information repository features are used, as described in more detail herein with reference to FIG. 5.

When mobile computing device 110 is within a transmission range of one of data packet generators 104, such as data packet generator 104a, the mobile computing device 110 receives a data packet from data packet generator 104a. In some embodiments, the data packet includes a code. The code is then communicated from mobile computing device 110 to base station 112, where it is routed to data packet generator server 116, through network 114.

Network 114 is a communication network capable of communicating digital data between computing devices. An example of network 114 is a wide area network, such as the Internet. Another example of network 114 is a local area network. Yet another example of network 114 is a telephone system. Some embodiments include a picocell or femptocell. In some embodiments, network 114 is a combination of multiple of these or other networks.

Communication across network 114 typically conforms to one or more standard data communication protocols. Examples of several of these protocols include the Internet Protocol (IP), Transmission Control Protocol (TCP) (or collectively as TCP/IP), Dynamic Host Configuration Protocol (DHCP), Hypertext Transfer Protocol (HTTP), File Transfer Protocol (FTP), Simple Object Access Protocol (SOAP), or other known protocols.

Data packet generator server 116 is communicatively coupled to network 114 and includes data packet generator database 118. In some embodiments the data packet generator database 118 resides on data packet generator server 116, while in other embodiments the data packet generator database 118 resides on a separate computing device that is accessible by data packet generator server 116.

In some embodiments, data packet generator server 116 operates to receive messages from mobile computing device 110, such as including a code from data packet generator 104a (or another data packet generator). When the code has been received, data packet generator server 116 uses the code to retrieve a location or other information from data packet generator database 118 that is associated with that code.

In some embodiments, each data packet generator 104 is assigned a single code, and therefore always includes the same code in its data packet. In this embodiment, data packet generator database 118 includes a table (e.g., a lookup table) that associates a given code with the respective data packet generator 104, such as data packet generator 104a. Additionally, in some embodiments, the data packet generator database 118 further includes location information for the respective data packet generator 104a, that identifies or describes the location of that data packet generator 104a.

In other embodiments, data packet generators 104 are programmed to change their codes occasionally or periodically. For example, in some embodiments each data packet generator is pre-loaded with a list of codes and programmed to begin with the first code at a predetermined time, and then to change codes periodically thereafter at a predetermined rate (e.g., once per minute, once per day, etc.). The data packet generator then cycles through the codes in the predefined order. The list of codes is also stored in data packet generator database 118, in some embodiments, along with the expected times that the codes will be used. The server can then identify the particular data packet generator 104a by knowing the code and the time that the code was received by mobile computing device 110. In another embodiment, the server identifies the particular data packet generator 104a by a sequence of codes and comparing the sequence to the lists of codes stored in data packet generator database 118 until a unique sequence has been identified as belonging to data packet generator 104a.

In yet another possible embodiment, data packet generators 104 are programmed to generate codes according to a predefined mathematical algorithm. The algorithm (or a seed/key of the algorithm) is also stored in data packet generator database 118 and associated with the respective data packet generator, which allows data packet generator server 116 to identify a code as originating from a particular data packet generator 104a at a given time.

In some embodiments, once the data packet generator 104 is identified, the location information or other data is retrieved from data packet generator database 118. In one example, a location of the consumer U1 is transferred to store server 120, along with network address information (or other contact information, such as a telephone number or an e-mail address). The location information and address information is then used by store server 120 to send additional information to mobile computing device 110.

In another possible embodiment, data packet generator database 118 includes a link associated with each location. The link is, for example, a URL to content that is available through store server 120. Once the location of consumer U1 is identified by data packet generator server 116, a message is sent back to mobile computing device 110 including the link. Mobile computing device 110 then uses the link to request additional information from store server 120, which is provided. Examples of such additional information include information (including one or more of text, music, audio, or graphics) relating to one or more products 140 that are in the vicinity of consumer U1, a coupon for one or more of the products 140, or other information as discussed in more detail herein.

In another possible embodiment, content can be displayed by the mobile computing device 110 upon receipt of a data packet from data packet generator 104, without requiring prior authentication or validation of the data packet before the content is released. Similarly, location-based actions can be performed by the mobile computing device upon receipts of the data packet, in some embodiments, as discussed herein.

FIG. 2 is a schematic block diagram of an example data packet generator 104, shown in FIG. 1. In this example, data packet generator 104 includes processor 202 (including memory 204), memory 206, timer 208, network interface 210, communication hub 212, network port 214, computer port 216, power supply 218 (including battery 220), wireless communication device 222 (including antenna 224), USB interface 226, and sensors 228 (including sensors 230, 232, and 234).

Processor 202 is a physical component that operates to process data instructions. In addition to the other examples described herein, another example of processor 202 is an ultra low power Wi-Fi chip, such as the GS1010 or GS1011, manufactured by GainSpan Corporation located in Los Gatos, Calif., US. In some embodiments, the frequency of broadcasts from processor 202 is pre-programmed. In some embodiments, the frequency is programmed to vary throughout the day (or another period such as a week). To maximize battery-life, the broadcast frequency can be correlated with the expected occupancy of the building (and/or other factors). For example, there may be fewer or no broadcasts occurring when a store is closed, and there may be more frequent broadcasts during a time when consumers are expected to be more responsive to promotions, etc. In some embodiments, a light sensor is used to conserve power. For example, the data packet generator 104 adjusts to a low power mode when the nearby lights are off, and adjusts to full power mode when the lights are on.

Memory 204 and 206 is provided for storage of digital data. Examples of memory are discussed herein. In some embodiments, memory 204 and/or 206 contains data instructions, which when executed by the processor, cause the processor to implement one or more of the methods, modules, operations, or functions described herein. For example, in some embodiments the data instructions cause processor 202 to generate a data packet. The data packets are generated periodically in some embodiments, such as described herein. In some embodiments the data packet includes a serial number of data packet generator 104, one or more passcodes, or other data. Examples of data that can be included in data packet generator 104 are described herein.

One or more timers 208 are included in some embodiments to provide timing signals. In some embodiments there are two or more timers. A first timer provides timing systems for general operation of data packet generator 104. A second timer is used for a real-time clock. The real-time clock is used to keep the data packet generator 104 synchronized with other data packet generators, such as to identify a common wake up time.

Some embodiments of data packet generator 104 include a network communication system including network interface 210, communication hub 212, and ports 214 and 216. However, some embodiments of data packet generator 104 do not include a network communication system. In other possible embodiments, data packet generator communicates with a network only through wireless communication device 222, and not through the separate network communication system. In some embodiments, data packet generator 104 does not communicate in a data communication network, other than to generate and transmit data packets.

Network interface 210 provides a data communication interface between processor 202 and communication hub 212. An example of network interface 210 is an Ethernet interface device.

Communication hub 212 is a network hub that permits data communication between network port 214 (which can be connected to a network, such as the Ethernet, for receiving network communications), network interface 210, and computer port 216 (which can be connected to a computing device, such as a personal computer). An example of communication hub 212 is an Ethernet communication hub. Communication hub 212 is, in various embodiments, a passive hub, an active hub, or an intelligent hub. When a packet is received at communication hub 212 from ports 214, 216 or network interface 210, the package is communicated to the other ports 214, 216 or network interface 210. A header of the package is read by the receiving devices to determine if the package is addressed to that device. If so, the package is received and processed by that device. If not, in some embodiments, the package is ignored (or discarded) at that device.

In some embodiments, data packet generator 104 further includes an electronic gate (not shown) configured between the communication hub 212 and network port 214. In this example, incoming packets received at computer port 216 from a computing device that are addressed to the data packet generator 104, can be selectively blocked by the electronic gate, while still being received at the network interface 210. Other communications, however, such as communications between a computing device and a server or another computing device, are allowed to pass through the electronic gate uninterrupted. In some embodiments, data packet generator 104 is a gateway. Other embodiments do not include an electronic gate and do not operate as a gateway.

Some embodiments of data packet generator 104 are not configured for network communication, and therefore may not include communication hub 212, network interface 210, and ports 214 and 216.

Power supply 218 provides power to data packet generator 104. In some embodiments power supply 218 includes one or more batteries 220. In some embodiments the battery 220 is small, such as sufficient to maintain data in memory 206, or to continue operating timer 208. In other embodiments, battery 220 is sufficient to fully power all of the components of data packet generator 104. Some embodiments include multiple batteries or sets of batteries. For example, some embodiments include a small battery used to power certain components, such as timer 208, and a second larger replaceable or rechargeable battery or set of batteries for powering other components that may require greater amounts of energy, such as processor 202 and wireless communication device 222.

In some embodiments, the energy capacity of the second larger battery or set of batteries is large enough to maintain adequate power to data packet generator components during normal operation for a period of time between recharging or replacing, such as for a period of one month, three months, six months, three years, etc. The energy capacity of the first smaller battery is, for example, sufficient to maintain adequate power to the timer (and/or other components of data packet generator 104, such as memory 206) to last for the life of the data packet generator 104.

Power supply 218 typically includes filtering electronics to supply a consistent power source to data packet generator 104. Further, some embodiments of power supply 218 receive power from an external source. For example, some embodiments of data packet generator 104 include a power cord or power input port for receiving a power cord. In another possible embodiment, power is received at power supply 218 from data ports 214 or 216, such as from a Power over Ethernet system. Some embodiments include solar panels to convert light into electricity. Other embodiments receive power from other sources, such as from electromagnetic waves or electromagnetic induction.

In some embodiments, data packet generator 104 includes a wireless communication device 222 that permits data packet generator 104 to send and/or receive data wirelessly, such as through antenna 224. In some embodiments the wireless communication device 222 transmits data according to a data communication protocol. Examples of data communication protocols include the 802.11 family of wireless communication protocols, the BlueTooth protocol, and the Wireless Gigabit Alliance (WiGig) protocol, and the near field communication protocol(s). Antenna type, signal strength, and casing characteristics are selected, in some embodiments, to control the wireless signal behavior at various locations in a building.

Some embodiments include additional communication devices, such as a universal serial bus interface 226. USB interface 226 operates to communicate with a USB device according to one or more USB communication protocols. In some embodiments power supply 218 receives power through USB interface 226. In some embodiments, external devices are connected with the data packet generator 104 through USB interface 226. Examples of external devices include a USB memory stick, a camera, an external sensor, or a wide variety of other external devices. Other communication protocols are used in some embodiments. Some embodiments do not include additional communication devices. Further, some embodiments do not include any ports or interfaces for connection with another device, other than wireless communication device 222. In some embodiments, data packet generator 104 includes a display. For example, some embodiments include epaper. In a more specific example, the data packet generator is integrated with an electronic shelf label that uses epaper to display product information. The electronic shelf label is wirelessly updateable in some embodiments. Examples of electronic shelf labels include products currently offered by ZBD Displays LTD of Skokie, Ill.

Sensors 228 are included in some embodiments. Other embodiments include multiple sensors, such as sensors 230, 232, and 234. Examples of sensors include tamper sensors (such as a screw presence sensor), position sensors (including GPS receivers, altitude sensors, distance from floor or ceiling sensors), movement sensors (such as an accelerometer), temperature sensors, user presence sensors (e.g., heat, motion, or sound sensors), smoke detector, asset tag sensor (such as an RFID receiver or 802.11 communication device), gyroscope, or other sensors. Some embodiments do not include sensors 228.

Some embodiments include multiple different data packet generator 104 configurations, intended for different purposes. For example, some embodiments have different housing sizes, configurations, and materials; different antenna designs to direct radio frequency signals; different energy capacities; different broadcast power settings for transmitting radio frequency signals to different distances; different broadcast frequencies for transmitting data packets at different intervals of time; different connection options, such as for permanent connection or removable connection, etc. Several examples are as follows.

One example data packet generator 104 is configured to be permanently installed at an end cap of an aisle in a retail store. This end cap configuration is designed of a durable housing with a permanent fastening mechanism for coupling the data packet generator at that location in a way that is difficult for an unauthorized person to remove it. The end cap design is configured for higher traffic areas where consumers may tend to pass by more quickly. As a result, the end cap configuration can include a faster broadcast frequency, a broadcast power adequate to reach mobile computing devices of consumers as they pass by the end cap, and an antenna design configured to send data packets directly in front of the end cap (or, alternatively, in front and around to both sides of the end cap).

Another example data packet generator 104 is configured to be placed adjacent a product in an aisle. This data packet generator 104 has a lower broadcast frequency, because the consumer is likely to move more slowly in this area. Another possible data packet generator 104 is configured to be placed in or on a ceiling, and is adapted to provide signals to mobile computing devices 110 of consumers as the consumers pass below. In some embodiments the antenna 224 of a ceiling model will be highly directional (such as so the signal is detected only when the consumer passes directly below the data packet generator). In other embodiments, the antenna is configured to generate a wide angle signal to be received in a larger area of the retail site. Some data packet generators 104, such as the ceiling mounted embodiment, can broadcast multiple data packets simultaneously and/or in different directions.

Another possible example data packet generator 104 is configured for use at a point of sale, such as near the cash register. Because power is often readily available in this area of a retail site, the point of sale configuration may be designed to be hardwired rather than, or in addition to, being battery operated. This is also the case for some ceiling installations.

Yet another possible data packet generator 104 is configured for temporary use, such as on a rack or temporary display. This configuration may include a temporary fastener, such as adhesive or screws that permits easy and quick installation on a temporary rack or display (e.g., for a sale or promotion). The configuration may also include a smaller battery with less energy capacity. In some embodiments, the data packet generator is designed with inexpensive materials and is designed to be disposed of after temporary use.

In some embodiments, all battery operated data packet generators include a single interchangeable battery pack configuration.

FIG. 3 is a schematic block diagram illustrating an architecture of an example mobile computing device 110. Although described herein as an example of the mobile consumer's (user U1) mobile computing device 110, the computing device shown in FIG. 3 is also an example of a suitable architecture for cash register 106, computing device 108, and servers 116 and 120. The various computing devices described herein (including mobile computing devices, cash registers, servers, etc.) can be implemented in a variety of different forms in other possible embodiments, including, for example, a tablet computer, a desktop computer, a smart phone, a personal digital assistant (PDA), a conventional cash register, an iPod™ device or iPad™ device, or one of the many other possible devices that are configured to process data instructions.

Mobile computing device 110 includes, in some embodiments, at least one processing device 202 and memory 204. A variety of processing devices 302 are available from a variety of manufacturers, for example, Intel Corporation or Advanced Micro Devices, Inc. In some embodiments, the processing device 302 is configured to perform one or more methods or operations as defined by instructions stored in memory.

Mobile computing device 110 also includes, in some embodiments, at least one memory device 304. Examples of memory 304 include read-only memory 308 and random access memory 310. Basic input/output system 312, containing the basic routines that act to transfer information within mobile computing device 110, such as during start up, is typically stored in read-only memory 308. Memory device 304 can be a part of processing device 302 or can be separate from processing device 302.

In this example, mobile computing device 110 also includes system bus 306 that couples various system components including memory 304 to processing device 302. System bus 306 is one of any number of types of bus structures including a memory bus, or memory controller; a peripheral bus; and a local bus using any of a variety of bus architectures.

In some embodiments, mobile computing device 110 also includes secondary storage device 314 for storing digital data. Examples of secondary storage devices are memory devices or hard disk drives. Secondary storage device 314 is connected to system bus 306 by secondary storage interface 316. Secondary storage devices 314 and their associated computer readable media provide nonvolatile storage of computer readable instructions (including application programs and program modules), data structures, and other data for mobile computing device 110.

In some embodiments, secondary storage device 314 is one of a variety of types of computer readable media. Examples of computer readable media include magnetic cassettes, flash memory cards, digital video disks, Bernoulli cartridges, compact disc read only memories, digital versatile disk read only memories, random access memories, read only memories, hard disc drives, or other memory devices.

A number of program modules can be stored in secondary storage device 314 or memory 304, including operating system 318, one or more application programs 320, other program modules 322, and program data 324. In some embodiments, program modules include data instructions that are stored in computer readable media (such as computer readable storage media). The data instructions, when executed by the processing device 302, cause the processing device 302 to perform one or more of the methods, operations, or functions described herein.

One example of an application program 320 is a browser software application. A browser software application operates to communicate according to known data communication protocols across network 114. For example, in some embodiments the browser software application requests web page data from store server 120 via a Uniform Resource Locator (URL) link. In some embodiments the store server 120 responds with web page data, which is interpreted by the browser software application according to a protocol, such as HTML, and displayed on display device 342 to display the web page data to the user. The browser software application can also receive inputs from the user, such as through one or more input devices 330, and transfer data associated with the inputs to server 120 in some embodiments. Several examples of browser software applications include the Internet Explorer® Mobile browser, Blackberry® browser, Android® browser, Nokia® series 40 browser, and the Safari® browser.

In some embodiments, while a user is interacting with the browser software application, the user's present location can be determined as described herein. Information related to the user's current location can then be displayed through the browser, such as to display an advertisement relating to the user's current location.

In some embodiments, content is not transmitted by store server 120 as a URL and does not include web page data. Rather, in some embodiments content is directly displayed by a software application, other than the browser, and the browser is not used to display the content.

In some embodiments, a user provides inputs to the mobile computing device 110 through one or more input devices 330. Examples of input devices 330 include keyboard 332, pointing device 334 (such as a trackball), touch sensitive display 336 (or a touchpad), and microphone 338. Other embodiments include other input devices 330. Input devices 330 are often connected to the processing device 302 through input/output interface 340 that is coupled to system bus 306. These input devices 330 can be connected by any number of input/output interfaces, such as a parallel port, serial port, game port, or a universal serial bus. Wireless communication between input devices and interface 340 is possible as well, and includes infrared, BLUETOOTH® wireless technology, 802.11a/b/g/n wireless communication, WiGig, cellular communication, or other radio frequency communication systems (such as near field communication) in some possible embodiments. Although input devices and other components of mobile computing device 110 are displayed as being parts of the computing device 110, in other embodiments one or more of the components is an external component that interfaces with mobile computing device 110. An example is an external display device 342 or an external wireless network communication device 350.

Some embodiments utilize a Subscriber Identity Module (SIM) sticker. Some embodiments utilize Wi-Fi direct.

Output devices are included in some embodiments, such as a sound generator 339 (including a speaker, head phones, or the like), for generating sounds that can be heard by the user.

In some embodiments, a display device 342, such as a monitor, liquid crystal display device, projector, or touch screen display device, is also connected to system bus 306 via an interface, such as display adapter 344. In addition to display device 342, the mobile computing device 110 can include or interface with various other devices, such as a printer, a digital camera, a digital camcorder, or other devices.

When used in a local area networking environment or a wide area networking environment (such as the Internet), mobile computing device 110 is typically connected to network 114 through a wireless network communication device 350 including antenna 352. In another possible embodiment, computing device 110 includes a network adapter for wired communication to network 114, such as through an Ethernet port and cable. In another possible embodiment, mobile computing device 110 can be coupled to another computing device, such as through a USB port or other docking station. Other possible embodiments use other communication devices. For example, some embodiments of mobile computing device 110 include a modem for communicating across network 114. In yet another example, mobile computing device 110 is prepared for interruptible data communication with network 114, such as when the information repository features are used, as described in more detail herein with reference to FIG. 5.

Some embodiments further include a radio receiver 353 coupled to an antenna 355. In some embodiments, antennas 352 and 355 are the same, while in other embodiments separate antennas are used. For example, separate antennas can be beneficial so that each antenna can be tuned to the appropriate ranges of frequencies. In addition, separate antennas can permit simultaneous operation of the wireless network communication device 350 and the radio receiver 353. In some embodiments, radio receiver 353 includes a radio frequency receiver chip. Some embodiments include a radio tuner. Other filtering, mixing, and amplification electronics are included in some embodiments of radio receiver 353. The radio receiver 353 is configured to receive radio frequency signals broadcast from a radio frequency transmitter. Examples of radio frequency signals include frequency modulated (FM) radio signals and amplitude modulated (AM) radio signals. Examples of radio frequencies that can be used for transmitting and receiving radio signals include the AM radio band from 535 KHz to about 1.7 MHz, the short wave radio band from 5.9 MHz to 26.1 MHz, the citizens band radio from 26.96 MHz to 27.41 MHz, the television station band from 54 MHz to 88 Mhz and 174 MHz to 220 MHz, and the FM radio band from 88 MHz to 108 MHz. In some embodiments, antenna 355 and radio receiver 353 are tuned to receive frequencies with one or more of these bands. Other embodiments use other frequency bands.

Mobile computing device 110 typically includes at least some form of computer-readable media. Computer readable media include any available media that can be accessed by mobile computing device 110. By way of example, computer-readable media include computer readable storage media and communication media.

Computer readable storage media includes volatile and nonvolatile, removable and non-removable media implemented in any device configured to store information, such as computer readable instructions, data structures, operating systems 318, application programs 320, program modules 322, program data 324, or other data. Memory 304 is an example of computer readable storage media. Computer readable storage media includes, but is not limited to, read-only memory 308, random access memory 310, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by mobile computing device 110. In some embodiments, computer readable storage media includes computer non-transitory media.

Communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, communication media includes wired media such as a wired network or direct-wired connection, and wireless media such as acoustic, radio frequency, infrared, and other wireless media. In some embodiments, communication media is transitory media. Combinations of any of the above are also included within the scope of computer readable media.

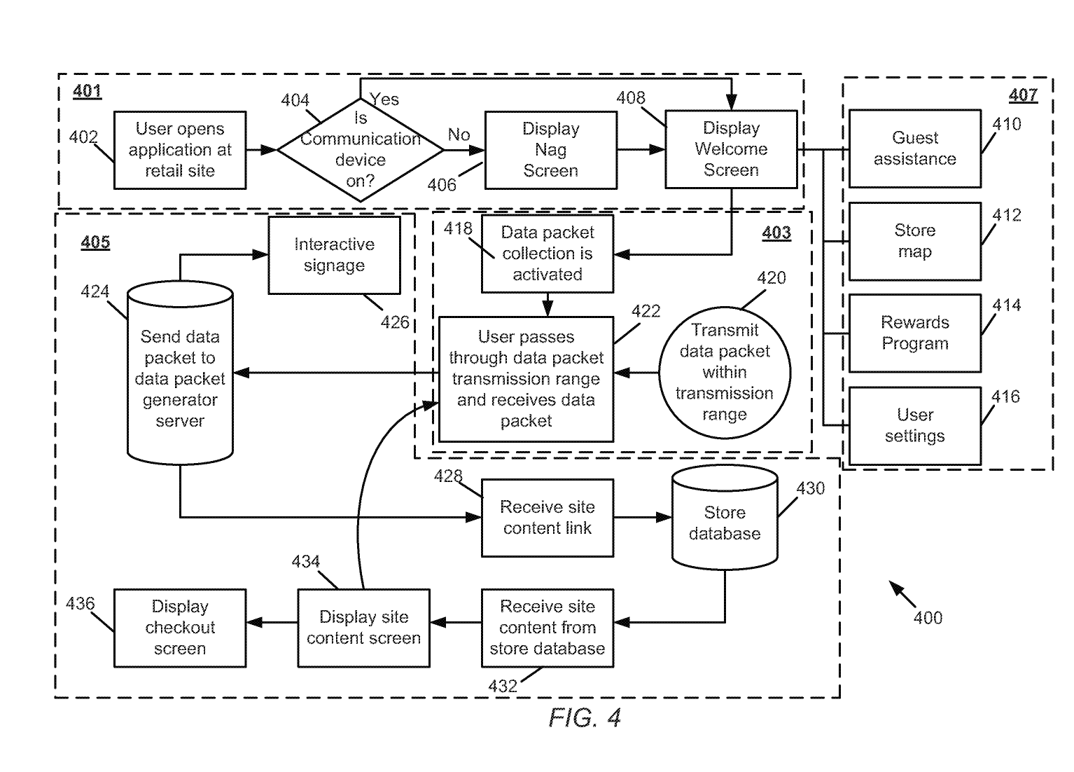

FIG. 4 is a flow chart illustrating an example method 400 of operating a consumer interface system, such as system 100 shown in FIG. 1. Some embodiments of method 400 include operations 401, 403, 405, and 407. An example of operation 401 includes operations 402, 404, 406, and 408. An example of operation 403 includes operations 418, 420, and 422. An example of operation 405 includes operations 424, 426, 428, 430, 432, 434, and 436. Other embodiments include other operations, such as discussed herein.

In some embodiments, method 400 begins with an initialization operation. An example of the initialization operation is illustrated in FIG. 4, and as noted above, includes operations 402, 404, 406, and 408.

Operation 402 is performed, for example, when the consumer U1 opens a software application on mobile computing device 110, such as when the consumer is at a retail site 102.

Operation 404 then determines whether the wireless network communication device 350 is active on mobile computing device 110. If not, a nag operation 406 is performed to prompt the user to turn on or enable the wireless network communication device 350. In another possible embodiment, if operation 404 determines that the wireless network communication device 350 is not active, another operation is performed to automatically activate the wireless network communication device 350. In some embodiments, when the wireless network communication device 350 is automatically activated, the wireless network communication device 350 is not permitted to join a wireless network, but is permitted to receive information about available wireless networks, such as network names, etc. to obtain a code as discussed herein. In some embodiments the wireless network communication device 350 is automatically deactivated when collection of codes has been completed.

If the wireless network communication device 350 is active, operation 408 displays the welcome screen on mobile computing device 110. In some embodiments, the welcome screen is displayed only after a code has been received from a data packet generator 104 that indicates that the consumer is near to or has entered the retail site, such as when the consumer is at or near the location of the entrance to the retail site. In some embodiments, the welcome screen includes an instruction to the consumer to move about the retail site. In some embodiments, a variety of selectable options are displayed or otherwise made available to the consumer through welcome screen 408, or a subsequent home screen. Upon selection of one of the selectable options, one of the other operations 407 is performed, such as one of the example operations 410, 412, 414, and 416, which are discussed in more detail below.

Other embodiments include different initialization operations 401. For example, in some embodiments operation 401 involves the operation of an application manager software application. The application manager program manages a variety of different retail site applications, and operates to start the appropriate retail site application when the mobile computing device approaches or enters that retail site. The application manager program can operate with any building type described herein.

For example, the application manager operating on the mobile computing device monitors for the receipt of a token from operation 420, indicating that the mobile computing device is at or near an enabled location. In some embodiments the token is first evaluated to determine whether the token is generated by a data packet generator, such as by checking a first portion (or other portion) of the token for a sequence of characters (e.g., “WP”). If so, in some embodiments the application manager automatically turns on the retail site app associated with that data packet generator or prompts the user to do so. If not, the application manager does not further evaluate the token and the token is deleted from memory. This provides privacy to the user, by only permitting the location-based services to operate when the user wants the services to be used. If the user permits the use of location-based services, which can be determined through a prompt, the token is further evaluated, such as to determine whether the token is in fact associated with the retail site whose software application has been installed or enabled on the mobile computing device. For example, in some embodiments the application manager provides a list of available retail sites, and permits the consumer to select which of the retail site applications should be installed or enabled. If the received token is associated with an installed or enabled retail site, the retail site application is activated, such as to display the welcome screen 408. In some embodiments the application manager prompts the consumer to ask whether the consumer would like to activate the retail site application, prior to activating the retail site application.

In some embodiments the application manager opens during the startup of the mobile computing device. In some embodiments, the retail site application is opened automatically upon the mobile computing device determining that it is near to or within the retail site, which may incorporate assisted GPS.

In some mobile computing devices, the wireless communication system is configured to be able to detect and receive some wireless communication even when the communication device is turned off. For example, the wireless communication can receive data packets from a data packet generator, but may not, for example, be permitted to join a communication network. In some embodiments, operations 404 and 406 are not included in operation 401.

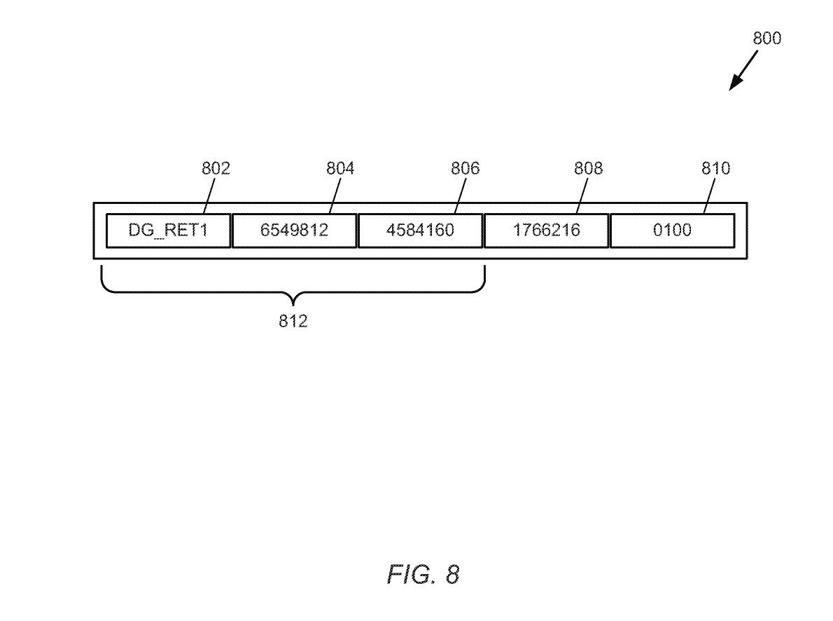

In some embodiments, operation 401 includes steps to pre-load information onto mobile computing device 110 at the beginning of the shopping experience at the retail site 102. This operation can be helpful, for example, when mobile computing device 110 may not have continuous access to a communication network 114. It is currently not uncommon for mobile computing devices, such as smartphones, to be unable to access a communication network when indoors. By pre-loading information onto the mobile computing device when the user comes into the retail site 102, for example, the content can be made available even if data communication with network 114 is lost. Even if continuous data communication is available, however, pre-loading can have advantages, such as to improve the response time of the software application by not requiring the application to wait for the information to be downloaded before it can be displayed. Combining pre-loaded content with data packets creates new features, such as those descried in FIGS. 8-13.

The pre-loading of information onto mobile computing device 110 typically occurs at or near to the entrance of retail site 102. In some embodiments the pre-loading occurs at the entrance while the mobile computing device is likely to still have access to network 114. In another embodiment, pre-loading occurs by the mobile computing device 110 temporarily joining a wireless network. In yet another embodiment, pre-loading occurs by the user placing the mobile computing device 110 in a docking station that is connected to network 114. For example, a kiosk is provided near the entrance to retail site 102. The kiosk includes docking stations and/or various communication cables for coupling the mobile computing device 110 to network 114. The software application then downloads information from one or more servers, such as store server 120. A kiosk may also be used to provide battery boosts for smartphones (since Wi-Fi can be a drain on smartphone batteries).

In another possible embodiment, content is loaded onto mobile computing device 110 by transmitting the content in radio signals with a radio transmitter, where the content is then received by radio receiver 353. For example, a retail site can include a short range radio transmitter that broadcasts data encoded in radio signals to mobile computing devices within the retail site, or a longer range radio transmitter that broadcasts data over an area larger than a single retail site, such as across part of all a city, town, state, or country. As shown in FIG. 3, some embodiments of mobile computing device 110 include radio receiver 353 that receives the radio signals when within the broadcast range of the radio transmitter. The radio receiver decodes the data from the radio signal and provides the data to processing device that stores the data in memory. In some embodiments, the data includes both content and codes or partial codes associated with the content. Although mobile computing devices 110 within the broadcast range can receive the same content from the radio signal, as discussed in more detail herein, access to the content is provided only upon receipt of codes associated with the content in some embodiments.

Therefore, in some embodiments content can be delivered through various possible levels of communications. A first level of communication provides all content (with associated codes or associated partial codes) to all mobile computing devices for at least temporary storage on the mobile computing device, such as by using a radio signal to broadcast to all mobile computing devices within the broadcast range. An advantage of this form of communication is that a single radio signal can be used to communicate with all of the mobile computing devices. A second level of communication provides a partial or complete list of codes to at least one specific mobile computing device that received communications in the first level. This second level of communication, which may utilize a 3G, 4G, Wi-Fi or other wireless or wired network connection, may take place near the entrance of a retail store in some embodiments. The codes can be selected for the consumer, such as based upon the consumer's preferences, past activities, privacy settings, demographics, etc. In the third level of communication, at least some of the stored content from the first level is revealed to the mobile computing device user once a token has been collected from a data packet generator. In some embodiments, collected codes are sent back to the server for analysis, which can be considered a fourth level of communication. These different levels of communication can be used individually or cooperatively to increase the efficiency of data transfer to mobile computing devices.

In some embodiments, the pre-loaded information includes a set of codes (or partial codes) that will be generated by the data packet generators during an interval of time, such as the next two hours. Other embodiments pre-load codes sufficient for shorter or longer intervals of time. An example of a partial code is the first 21 digits of a 32 digit code, such as including a seven digit store identifier, seven digit device identifier, and seven digit retailer authentication code. Other codes are used in other embodiments.

In some embodiments, the pre-loaded information includes content associated with the set of pre-loaded codes. The content can include, for example, coupons, promotions, incentives, displays, videos, audio, any of the other types of content described herein, or any other content capable of being output by mobile computing device 110. The content is associated with one or more codes so that when the mobile computing device 110 receives a code, the content associated with the code can be identified and presented to the consumer through the mobile computing device 110, as discussed below with respect to an alternative embodiment of operation 405.

A guest assistance option is provided in some embodiments to allow the consumer to request assistance from a store employee. Upon selection of the guest assistance option, operation 410 is performed to request assistance. As discussed in more detail herein, in some embodiments the location of the consumer is known. As a result, operation 410 operates to send a message that requests that a store employee come to the consumer's current location to assist the consumer. In one example, the message is communicated to store computing device 108, or alternatively to store server 120. For example, once store computing device 108 has received the message, the retail administrator (or another store employee) is notified that a consumer is in need of assistance and the location of the consumer. The store employee can then go to the consumer, or notify another store employee that is in the area, such as through a wireless communication system (e.g., radio carried by store employees), over a store intercom system, or electronically. In some embodiments, computing device 108 notifies the store employee electronically, such as through an electronic message sent to a mobile computing device carried by the store employee. The location of the consumer is included in the message to allow the store employee to locate and meet the consumer. If the consumer permits (such as based on user settings 416), in some embodiments the user's name is included with the message, such as to allow the store employee to personally great the consumer. In some embodiments, information is displayed to the store employee on a mobile computing device, such as including a map showing the location of the consumer that needs assistance, and possibly including information such as the user's name.

A store map option is provided in some embodiments to allow the consumer to view a map of the retail site. Upon selection of the store map option, operation 412 is performed to display the store map to the user on mobile computing device 110. In some embodiments, the consumer's current location is also displayed on the map, as represented by a graphical element, such as a star, circle, arrow, or other graphical element. In some embodiments, routes are displayed on the map to guide the consumer to a desired location. In some embodiments a list of possible locations is displayed, which can be selected by the consumer to identify the desired location. Examples of possible locations include departments of the retail site, an entrance or exit of the retail site, a customer assistance counter, a checkout, a restroom, a retail store (such as when the retail site is a mall), or the location of a particular product.

In some embodiments a shopping list feature is provided. In one example, the consumer can enter a list of items that the user wants to purchase from the store. The shopping list can then be viewed on mobile computing device 110, such as while the consumer is at the retail site. In some embodiments the store map operation 412 assists the consumer in locating items on the shopping list, such as by displaying a route through aisles of the store, or providing turn-by-turn directions. Instructions are provided, in some embodiments, to assist the consumer in locating particular products. For example, the mobile computing device informs the consumer when the user is in the vicinity of a product on the shopping list, and can also tell the consumer the specific location of the product (e.g., “on the top shelf next to the oatmeal midway down aisle 7” or “directly to your right”).

In some embodiments the direction of the mobile computing device 110 is known, such as by detecting a series of codes that indicate the direction of travel. In another possible embodiment, the actual orientation of the mobile computing device is detected at a moment in time, such as through an internal compass or other direction indication device.

In some embodiments a route is computed to direct the consumer along the shortest path through the store that will allow the consumer to collect all of the products on the shopping cart. In other embodiments, a route includes additional waypoints, such as to bring the consumer to additional sale or coupon items that are likely to be of interest to the consumer. In some embodiments, routes are not based on the locations of products in a shopping cart. For example, in some embodiments the route is based, at least in part, on the location of sale or coupon items. In another possible embodiment, the route includes other waypoints, such as a restroom, customer service counter, food court, a checkout counter, an entrance, and an exit. Data for the shopping list, map, waypoints, and routes is stored in one or more of the mobile computing device 110, the store's computing device 108, the store server 120, or another server (e.g., data packet generator server 116).

A rewards program operation 414 is performed in some embodiments to log the occurrence of events relating to a rewards program. For example, in some embodiments the consumer is awarded rewards points periodically as the consumer moves through a retail site. In some embodiments the reward points are awarded for each unique token that is received as the user moves through the site. In another embodiments, reward points are awarded based on the distance that the consumer has traveled in the store (e.g., feet, meters, blocks, miles, etc.), or an estimate or approximation of the distance. Distances can be computed, for example, based on the known locations of data packet generators that the consumer passes by, and the distances between the locations. In another embodiment, the reward points are awarded based on an amount of time that the user is in the store. Other embodiments award points upon the occurrence of other or additional events within a retail site (or group of retail sites). In some embodiments, collecting multiple tokens from the same data packet generator will not result in multiple reward points being accumulated. In some embodiments, reward point tokens are transferred from mobile computing device 110 to another computing device, such as data packet generator server 116, store server 120, or store computing device 108 in real-time or some time later.

The rewards program is, for example, an incentive program that encourages the consumer to visit the retail site (or group of retail sites) or to encourage increased interaction between the user and the retail site. While the retail site application is operating, a rewards management engine operates in the background to monitor for the occurrence of a rewards event, and awards reward points accordingly. In some embodiments the application user interface informs the user when a rewards point has been obtained, such as by playing a sound, vibrating, incrementing a rewards point total on the display, or displaying a message or graphic on the display.

In some embodiments, operation 414 is performed upon the selection of a Rewards Program option from welcome screen 408. Operation 414 displays a rewards program interface, such as to provide information about the rewards program, the status of the consumer's rewards program point total, permit the user to redeem rewards points, display information about how the rewards points can be redeemed and what they can be redeemed for, etc.

In some embodiments, the rewards program points can be redeemed for prizes, coupons, free or discounted goods or services, or other incentives. In some embodiments, the rewards program points accumulated for a given consumer are used to compute product prices or discounts. Rewards program points can also be used for a variety of other purposes. For example, consumers can be assigned to differing levels of consumers, such as platinum, gold, silver, bronze, etc. levels. Each level achieved provides better rewards, such as better coupons, specials, promotions, or product pricing. In some embodiments, reward program points can be redeemed for the goods, services, coupons, discounts, or other promotions of others. For example, in some embodiments the reward program points can be redeemed for reward program points of another company, such as airline frequent flier rewards. In some embodiments, reward program points are tied to a credit card rewards program, such as providing improved interest rates, larger credit lines, or other benefits for those having larger point scores.

A user settings option is provided in some embodiments to allow the user to set or adjust user settings or preferences. Upon selection of the user settings option from welcome screen 408, operation 416 is performed to display a user settings screen. In some embodiments, the user settings screen allows the user to enable or disable various optional features, to define privacy settings and select among various data collection options. After settings have been selected, the user's settings are stored in memory. In some embodiments, settings are transferred from mobile computing device 110 to another computing device, such as data packet generator server 116, store server 120, or store computing device 108.

In some embodiments, after the initialization operation 401, operation 403 is performed to collect tokens. An example of operation 403 includes operations 418, 420, and 422.

In some embodiments, operation 418 is performed by mobile computing device 110 to begin listening for the transmission of one or more data packets from one or more data packet generators 104, so as to receive one or more data packets when available.

Operation 420 is performed by one or more data packet generators 104 to transmit data packets within a transmission range of the data packet generator 104. In some embodiments, the transmission range is relatively short, such as less than about 20 feet, less than about 10 feet, or less than about 5 feet. Other embodiments include other transmission ranges, such as longer or shorter transmission ranges. The transmission range of a data packet generator 104 is, for example, the distance at which the amplitude (e.g., dBm) of the transmission signal has attenuated to a level where the signal is no longer consistently detectable by the mobile computing device 110. Some embodiments include different types of data packet generators, where some data packet generators have a shorter range, and other data packet generators have a longer range. Examples of longer ranges include 20 feet, 1,000 feet, 1 block, and 1 mile or more. Examples of shorter ranges include 3 inches, 6 inches, and 12 inches.

Operation 422 is performed to receive the data packet while the mobile computing device 110 is within the transmission range of at least one of the data packet generators 104.

After receiving a data packet, operation 405 is performed to release content associated with the data packet. An example of operation 405 includes operations 424, 426, 428, 430, 432, 434, and 436. This example illustrates an embodiment in which communication between the mobile computing device and network servers and databases is continuously available. Other embodiments operate with interrupted connectivity, as discussed herein.

Operation 424 is performed in some embodiments to send the data packet from mobile computing device 110 to a network server, such as data packet generator server 116. Upon receipt of the data packet, data packet generator server 116 identifies a code contained within the data packet, and retrieves from data packet generator database 118 information associated with the code, if any. If no information associated with the code is stored in data packet generator database 118, for example, data packet generator server 116 determines that the code is not a valid code from a data packet generator. In some embodiments the code is discarded or logged. In another possible embodiment, a message is returned to mobile computing device 110, such as to inform the user that an invalid code has been received. If the code is valid, information associated with the code is retrieved, such as an identification of the data packet generator 104 that transmitted the code, an identification of where the data packet generator is located, or an identification of a product located near to the data packet generator.

In some embodiments, before sending the code to data packet generator server 116, mobile computing device 110 operates to check whether the token is likely to have originated from a data packet generator. For example, in some embodiments all codes conform to a protocol, such as including a standard first portion composed of a predetermined set of characters, followed by an additional set of characters. For example, in some embodiments all codes begin with the characters “WP” and are followed by 30 additional characters. Other protocols are used in other embodiments. For example, some protocols for automotive showrooms incorporate the seventeen digit vehicle identification number (VIN).

If the received code does not conform to the protocol, the mobile computing device 110 determines that the code was not generated by a data packet generator, and does not send the information to data packet generator server 116.

As discussed herein, some embodiments of data packet generators transmit the code as a network name according to a wireless communication standard, such as the 802.11 family of wireless communication standards. Accordingly, the mobile computing device receives the network name and evaluates the network name as discussed herein. It is possible that other wireless networks will be detectable by the mobile computing device. The protocol discussed herein, such as including a unique first portion in the network name, permits the mobile computing device to easily distinguish network names that are likely to have been generated by a data packet generator from other network names (such as the network name for a wireless access point) that were not generated by a data packet generator.

In some embodiments the first portion (or other portion) of the code includes a retailer code. In some embodiments the consumer defines preferences for which retail site the consumer wants to interact with, and mobile computing device 110 (or data packet generator server 116) checks the retailer code to determine whether or not the retailer is one that has been selected for interaction. As always, all data collected about the user and the user's information is managed according to a clearly defined privacy policy and/or terms of use policy, which is presented to the user, such as upon the user's initial registration with system 100. In some embodiments data that is collected is not stored as being associated with a particular consumer to maintain the consumer's anonymity and privacy. In some embodiments, data collected is stored in a similar manner to the way cookies are stored in an Internet browser, and the consumer is permitted to select from various options for the storage of such information in a similar manner. The United States Federal Trade Commission's Privacy By Design initiative provides good information on how privacy considerations should be handled.

In some embodiments, once the user's location has been determined by data packet generator server 116 (or another server, such as the store server 120), operation 426 is performed to generate interactive signage associated with the user's location. In some embodiments, interactive signage is displayed on a display device by a computing device located in retail site 102. Examples of interactive signage include messages about one or more products that are near to the consumer, coupons or sales associated with such products, informational displays (such as nutrition facts, company information, etc.), internal digital signage, a movie trailer, or a variety of other displays. In some embodiments, displays include advertisements. Displays can include images, text, video, combinations of these, or other display formats. Some embodiments output information in other formats, such as audio through a sound generator 339. In some embodiments, data packets being collected at approximately the same time by more than one mobile computing device 110 result in deeper discounts being offered at that time to those users. Similarly, in a cinema environment, multiple mobile computing devices can be used to vote in real-time for alternate endings to movies. Similarly, bands performing a concert at a stadium can allow their fans to vote on playlists, with preference given to the fans in the best seating areas. Many such group functions are possible.

In some embodiments, rather than generating interactive signage 426, content is released to the mobile computing device upon receipt of a data packet. For example, a link to additional content is sent from the server to the mobile computing device, in some embodiments.

Operation 428 is performed, in some embodiments, to receive the link at mobile computing device 110 from data packet generator server 116 (or other server). In some embodiments, the link is a Uniform Resource Locator (URL) to a web page of store server 120. Mobile computing device 110 uses the link to request and obtain site content from store server 120.

Operation 430 receives the request from mobile computing device 110 and retrieves the requested data, such as data stored in store database 122 that is associated with the consumer's current location within retail site 102. The data is then sent to mobile computing device 110.

Mobile computing device 110 receives the site content in operation 432 and displays the content in operation 434, such as with a site content display screen.

In some embodiments, as the consumer continues to move within retail site 102, mobile computing device 110 continues to monitor for and receive data packets from additional data packet generators, such as in operation 403. The process is repeated in some embodiments until the user exits the retail site or closes the software application. In another possible embodiment, the application is timed to expire after a predetermined period of time has passed (e.g., seconds, minutes, or hours).

In some embodiments, one or more checkout screens are displayed with operation 436. Operation 436 can be automatically displayed, for example, when the consumer U1 and/or mobile computing device 110 are detected in the vicinity of the checkout counter 150 of retail site 102.

For example, if a coupon was displayed to the user as site content 432, the coupon can be retrieved by the user and displayed on mobile computing device 110. In some embodiments, the coupon includes a barcode that can be scanned at the checkout counter to enter the coupon into the cash register 106. In another embodiment, the coupon includes an identifier that can be manually entered by the user or cashier. In another possible embodiment, when the user enters the checkout area, the information about coupons or other sales that were displayed to the user while shopping in retail site 102 are made available for use by cash register 106 or another associated computing device (e.g., computing device 108 or server 120). If a product identifier associated with any of the coupons is entered into the cash register at checkout, the coupon or sale price is automatically applied to the purchase. The checkout process is then completed and a payment is received from the consumer. These processes can be consolidated when the point of sale occurs on the mobile computing device rather than at a traditional cash register, as might be the case for heavy electronics that the guest would like shipped or private items.

In some embodiments, operation 436 displays a summary of the shopping experience, such as the number of store miles that were accumulated, the amount of money that was saved by using coupons or due to sale prices, a comparison of the products purchased to the items identified in the shopping list, or other information. In some embodiments, payment is received by the user authorizing a payment through mobile computing device 110. In some embodiments, the receipt of the payment can be confirmed by cash register 106. In some embodiments, the location of the mobile computing device 110 in the retail site 102 is a factor for authenticating a transaction. For example, in some embodiments a credit card transaction is only permitted if the mobile computing device has received a data packet at the point of sale (e.g., checkout counter 150, shown in FIG. 1). Similarly, transactions occurring at an ATM's can be authenticated.

Other embodiments of operation 405 include different operations than the example shown in FIG. 4. For example, some embodiments are configured to operate even if network connectivity is interrupted, or may be interrupted. As discussed above, in some embodiments codes or partial codes are provided to and pre-loaded into mobile computing device 110 at the beginning of the shopping encounter, along with the associated content. In this embodiment, operation 405 may proceed as follows.

After the data packet has been received in operation 422, the code within the data packet is compared to the set of pre-loaded codes. If the received code (or a portion of the received code) matches one of the pre-loaded codes, and the pre-loaded code is associated with pre-loaded content, an operation is performed to display the content on the mobile computing device. In other words, in some embodiments the mobile computing device validates a received code as being a valid code to permit the content to be released without prior validation by one or more servers.

In some embodiments, this display of content is a push operation initiated by the software application, rather than a pull operation initiated by the user. Although the user has indicated an interest in receiving the content, in some embodiments the user does not control what or when specific content is presented. In some embodiments the frequency that content is displayed is limited, such as to avoid overwhelming or annoying the consumer. In some embodiments, the frequency is adjusted by the consumer's settings, such that the consumer can indicate how frequent content can be presented. In another embodiment, the frequency is adjusted according to the consumer's user profile or demographics. In some embodiments, the signal strength (e.g., RSSI) can enable different levels of content to be accessed. Achieving the strongest signal strength may require intentionality on the part of the user. Users can be made aware of additional features awaiting them if their smartphone is held very close to a data packet generator.

Some content can only be viewed by a consumer while the mobile computing device is in the vicinity of the data packet generator. However, if the user wants to save the content, such as a coupon, an option is provided to the user to Collect or Save the content. Upon selection of the option by the consumer, the mobile computing device saves the content for subsequent use by the consumer, such as during checkout. For example, the content is flagged in memory by the mobile computing device 110 for later use at checkout by operation 436.

Following the receipt of a data packet in operation 422, an operation is performed to transfer the code from the data packet to one or more servers, such as store server 120 or data packet generator server 116. The transfer can occur, for example, the next time that a connection to network 114 is obtained, the next time that mobile computing device 110 is connected to the in-store kiosk for pre-loading of content, or at another time. Upon receipt of the code from the mobile computing device, the code is further evaluated by the server in some embodiments to confirm the validity of the code. The code can be evaluated to check a diagnostic portion of the code that includes performance information, such as battery life, error codes, etc. Timestamps, such as cellular timestamps, are typically used to indicate when the data packet was obtained.

In some embodiments, upon receipt of the code at the server, a cash transfer is initiated. The cash transfer involves, for example, a payment from a vendor, wholesaler, or other third party to the store in an amount associated with the release of content to the consumer. Other payments may also be included, such as a payment to a company managing the data packet generators and data packet generator server.

A log of user activity can be stored in one or more of servers 116, 120 (or associated databases), computing device 108, and/or mobile computing device 110 in some embodiments, provided that the consumer has consented to such collection of data. Such information can then be compiled to provide useful information, such as to identify a percentage of advertisements that were displayed to a consumer that also resulted in sales. In some embodiments the data includes consumer demographics or other characteristics to assist in identifying consumers more likely to be interested in particular content than other consumers. Again, all such information is stored according to a clearly defined privacy policy and/or terms of use policy. The user is permitted to opt out of such data collection through user settings, or to permit only anonymous data collection, in which case data is stored but is not associated with the consumer's name, user identifier, or otherwise able to be associated directly with the user. Various dashboards can be used to compile the data and make it visually meaningful for decision-making.

In some embodiments, the consumer can indicate an interest in certain products or information by providing a product or information identifier, such as by taking a photograph of a QR code associated with a product with the mobile computing device 110. This is sometimes referred to as a pull, because the consumer is putting in a specific request for certain information or products.

Referring back to operation 422, in some embodiments, the mobile computing device 110 operates to check for data packets periodically, rather than continuously, to conserve its own battery power. In such embodiments, the broadcast frequency of the data packet generator 104 should be selected to ensure that data packets are likely to be received by a mobile computing device 110 when in the range of the data packet generator 104. In some embodiments the frequency of mobile computing device 110 operating to check for data packets is adjusted based on a measurable factor, such as movement detected by an accelerometer in the mobile computing device. The accelerometer can indicate how fast the user is moving, for example. Movement data can also be reported from the mobile computing device, such as to the store server in some embodiments. The data can be bundled with the transmission of codes to the server, for example.

FIG. 5 is a flow chart illustrating an example method 500 of operating a consumer interface system within the constraints of limited network access and required timeliness of content delivery, such as the consumer interface system shown in FIG. 1. In this example, method 500 includes operations 502, 504, 506, 508, 510, 512, 514 and 516.

In some embodiments, method 500 begins with operation 502, such as when a software application running on mobile computing device 110 downloads content and/or passcodes that can be used to release content. Such downloads of content and/or passcodes can happen at anytime and anywhere, such as when the consumer is at a retail site 102 or before the consumer arrives at retail site 102. Loading content and/or passcodes onto the mobile computing device 110 ahead of time facilitates quick content delivery if network access is interrupted or if the speed of the person walking through the store exceeds the timeliness of content delivery through the network. This can also make products such as the iPod Touch appear to have some degree of storewide Wi-Fi access, even when storewide Wi-Fi access is not available.

Operation 504 then determines whether now is an approved time to collect passcodes and/or release content. If now is not an approved time, such as would be the case for sale-specific content two hours before the sale begins, operation 506 causes no action or alternative actions to be taken, such as suggesting that the consumer return in two hours to take advantage of the sale. If now is an approved time to collect passcodes and/or release content, operation 508 causes passcodes to be collected. It is possible that additional passcodes are collected during operation 508 besides those passcodes associated with content delivery. Once passcodes associated with stored content are collected, content may be displayed and/or otherwise accessed in operation 510. Operation 512 then determines if the activity should be recorded for data mining. If yes, operation 514 records the activity. If no, operation 516 deletes or doesn't record the activity. Sometimes users are given the option to make the decision in operation 512, and sometimes the consumer is incentivized to make a decision that the retailer wants them to make, such as to indicate whether they enjoyed the content they received.

In some embodiments, operation 504 is not performed. In other words, in some embodiments passcodes are collected regardless of whether the current time is an approved time to collect passcodes or release content.

Some embodiments include a method of collecting rewards points or content even in the absence of a network connection. As one example, data packet generators are programmed to transmit data packets periodically, such as every few seconds, while changing a token contained within the data packet periodically, such as every 15 minutes. When a user enters the store with a mobile computing device, the mobile computing device downloads content (e.g., such as illustrated in operation 502). In one example, the content includes two hours worth of content (including tokens/passcodes, and the associated content). For example, if a site includes 100 data packet generators, and those generators change every 15 minutes, 800 tokens are downloaded to permit two hours of operation. Other embodiments include other quantities of tokens and/or content. When a network connection is established, the data is transferred to the server (e.g., server 116 or server 120). In another possible embodiment, the data is transferred the next time the user enters the site, such as during operation 502.

If a network connection is available to the mobile computing device throughout retail site 102, the prior download of the content is not performed in some embodiments. It still may be beneficial, however, since the prior download of content combined with tokens/passcodes creates new features, such as those described in FIGS. 8-13.

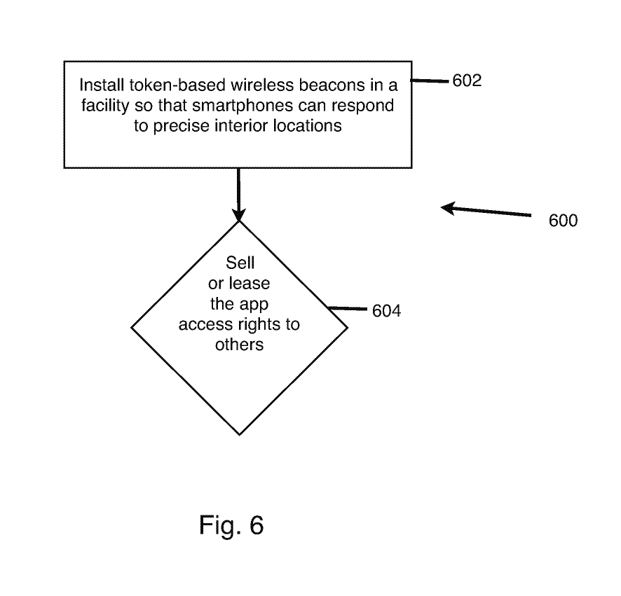

FIG. 6 is a flow chart illustrating an example method of adding token-based wireless beacons to a facility and then selling application access rights to a third party. In some instances (such as in stadiums where the naming rights to the stadium can be quite valuable) it may be advantageous for the building owner (or building controller) to sell the application access rights that unlock the wireless beacons installed throughout all or part the facility. For example, if the Mall of America application was the only application that could unlock the passcodes or tokens or wireless beacons at the Mall of America Field, then the building owner (or naming rights controller) could potentially increase their revenues by charging the Mall of America for this privilege that likely included access to an API.

Data mining can be used in many ways, including to improve the performance of the retailer and/or enhance the consumer's in-store experience. In some instances, the approval or acceptance of a first promotion unlocks the delivery of additional promotion(s) before further data mining is conducted.

Sometimes products promoted as part of a location-based display are purchased in the store for home delivery, as might be the case for heavy items or for personal items that the consumer would rather not be viewed by the checkout assistant.

Wireless data demand in stadiums is sometimes too high. For example, if instant replay videos were made available to all smartphone attendees at a professional football game, the wireless data network may be overwhelmed or slowed. Authenticating interior locations using the methods described herein can be used to deliver premium content to premium seats. In this method, the content itself is the preferred deliverable (not another product being promoted) and the achieved result is content management during times of peak demand and at other times. Seating prices that incorporate a premium content delivery surcharge can in turn be used to gradually extend premium content delivery throughout a stadium by means of data infrastructure improvement projects.

In another possible embodiment, a mobile application on a mobile computing device is used by consumers to place orders, such as for food or drink. The mobile application identifies the location, such as the particular seat, of the consumer so that the food can be delivered directly to the consumer. In some embodiments the feature is enabled only for consumers in particular seats (e.g., premium seating) or for consumers who have purchased a subscription to the mobile application in which the feature is enabled.

As building owners of all types seek to monetize the opportunity afforded them with the technology disclosed herein, some building owners may choose to charge third parties (who do not control the real estate) a premium for advertising in their space. For example, a retailer can charge its vendors a fee for delivering vendor promotions to the consumer while they are near the vendor's product. In these instances, if changing passcodes/tokens are used, splitting API access between the building owner and the vendor can result in authenticated promotion delivery whenever the computer program running on the mobile device returns the full passcode/token. For example, if an SSID token were used with 32 total digits, in some embodiments the digits utilized in the SSID token are provided by two or more different sources. A first source can provide a first portion of the SSID token (e.g., a retailer provides digits 1-16), and a second source can provide the second portion of the SSID token (e.g., a vendor provides digits 17-32). The API access to the tokens can be limited to the particular sources to prevent the other source from providing data for that portion of the SSID token. Splitting the API access even further is optional as well. Different quantities of digits can be allocated to each source in other embodiments, and different total numbers of digits can be used.

Some advantages of implementing aspects of the present disclosure include the following:

The system can be deployed relatively inexpensively, thereby avoiding huge upfront costs and generating immediate revenue, such as from mobile ad space. The system does not require a full site installation or signal mapping before the first mobile ad can be delivered.

The system is compatible with partial site deployments.

The system can generate a predictable signal pattern, which is not significantly affected by environmental factors, such as metal or shelving, and need not require continual remapping as the factors change.

The system can instantly authenticate mobile ad delivery for monetization by a company. Vendors purchasing ad space from the company can verify that ads were delivered by the system provider's validation code, as discussed herein with reference to FIG. 8. In contrast to requiring the vendors to trust the company and system provider that the content was provided, the system proves that the content was provided.

The system can be designed to be granular, and need not be inherently linear. This permits the content to be preloaded onto the mobile device and provided as needed, for example

The system cannot be mapped by third party mapping systems, such as by the Skyhook® hybrid positioning systems (XPS), which means promotions cannot be sent via third party applications. Control of the system can maintain with the site owner or company that controls the real estate. One reason that third parties would have difficulty mapping the data packet generators in a retail site is that the codes can be programmed to change periodically, such as every 3 or 6 months. This would require a complete remapping by third parties. More frequent code changes can be performed, if desired.

Some embodiments are examples of an interior precision location system, because the system precisely locates a mobile device, such as within a site or group of sites.

The present disclosure makes possible various types of interior location-based gaming. As several examples, the present disclosure describes a system that can be used to implement a life-sized Pac Man or other arcade style game. In another possible embodiment, the present disclosure describes a system that can be used to implement a scavenger hunt. In some embodiments, a game is provided as an incentive to the user to turn on or enable the application on the user's mobile computing device to permit other features disclosed herein.

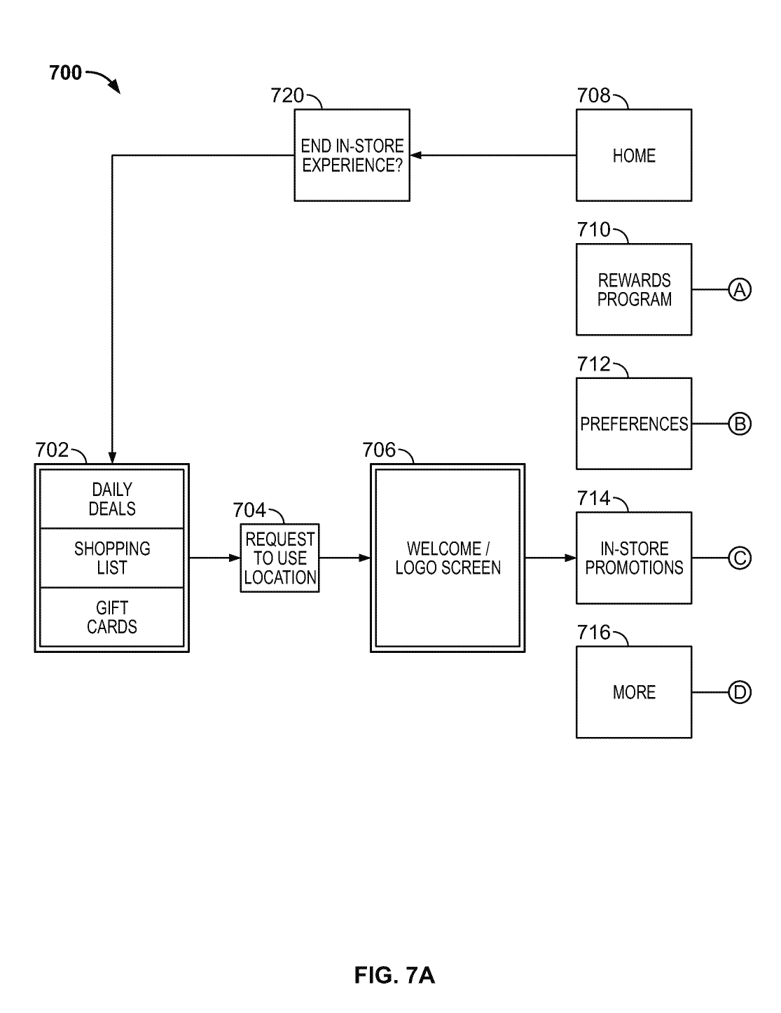

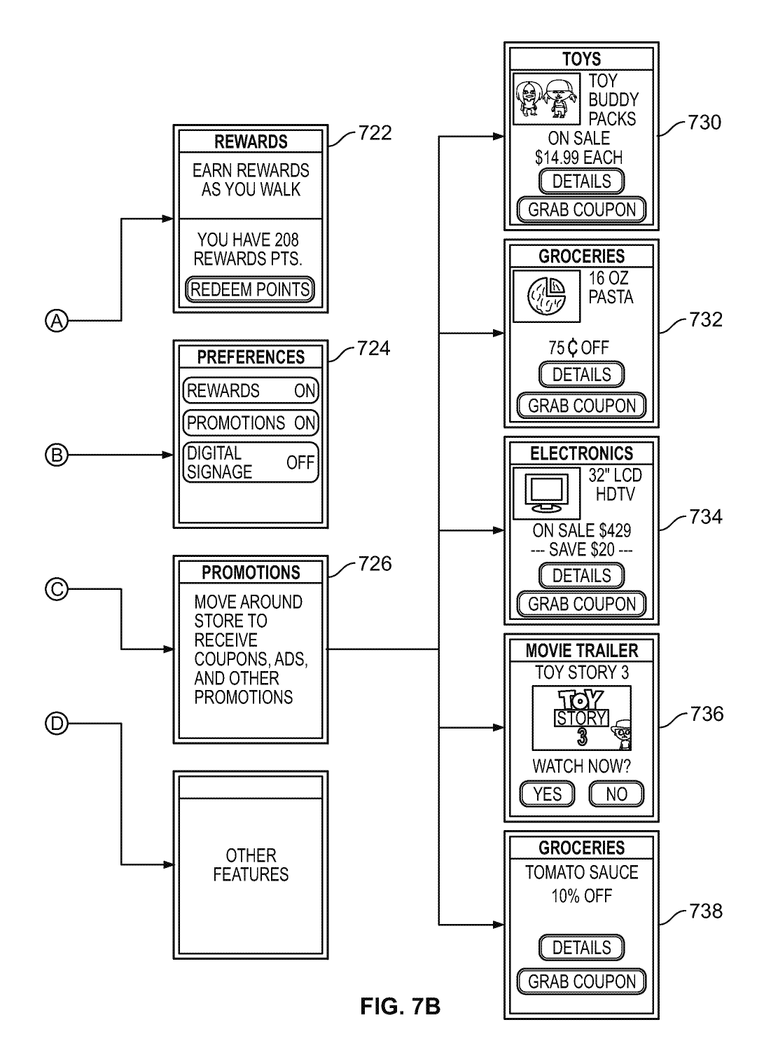

FIG. 7 (including FIGS. 7A and 7B) is a flow chart illustrating an example user interface 700 of a retail store's software application operating on a mobile computing device. The user interface includes a plurality of different exemplary user interface displays that can be displayed to the user by the mobile computing device as the user interacts with the system disclosed herein.

In this example, user interface 700 begins with an home screen 702, which presents the user with several selectable options, such as to view the store's daily deals, create a shopping list, or purchase or redeem gift cards. In some embodiments, home screen 702 is an application manager program that is associated with various different retail store applications.

In some embodiments, once the software application detects that the mobile computing device is at or near to a retail store, the application prompts the user with a display 704 that asks the consumer whether the software application can identify the consumer's current location. If so, the appropriate software application is activated and a welcome screen 706 is displayed in some embodiments. In some embodiments, a pre-load of content and associated codes occurs.

Consumer behavior can be impacted when the current total value of available coupons, discounts, and promotions has been made known to them. For example, if a consumer is aware that $200 worth of mobile ads have been preloaded into their mobile computing device, that consumer is more likely than someone else to spend time roaming the store to discover what coupons, discounts, and promotions are available. In some embodiments the total value is displayed in promotions screen 726, or in another screen of the user interface 700. It should be noted that coupons, discounts, and promotions can be added or removed while a person is in a store (impacting the total amount available to them). This aspect of consumer behavior represents yet another reason to pre-load content.

The welcome screen 706 presents a variety of selectable options, such as an option 708 to return to the home screen 702, an option 710 to review rewards program information, an option 712 to adjust preferences, an option 714 to explore in-store promotions, and possibly other options 716.

If the consumer selects option 708, in some embodiments the software application displays a confirmation screen 720 to confirm that the consumer would like to end the in-store experience. If so, home screen 702 is displayed.

If the rewards program option 710 is selected, information about a retail site rewards program is displayed in the rewards program screen 722. For example, the rewards program screen can display information about the rewards program, such as “Walk around the store and earn rewards points that can be redeemed for coupons, discounts, or other promotions. The more you walk, the more you earn!” The rewards program screen 722 can display a current rewards points value that the consumer has obtained, or a number of rewards points that are available to redeem. A selectable control to redeem the points is provided in some embodiments, and upon selection, the software application guides the user through the redemption process. It is possible that underselling products can be made available for redemption, either by the retailer or by the provider of consumer packaged goods (CPG).

If the user preferences option 712 is selected, a user preferences screen 724 is displayed, which allows the user to provide input regarding the operation of the software application. For example, user preferences screen 724 allows the user to turn on or off various features of the software application, such as the rewards program collection, the display of in-store promotions, the interaction between digital signage in the store, or the adjustment of other options.

If the in-store promotions option 714 is selected, the promotions screen 726 is displayed. The promotions screen 726 can display instructions, such as “Move around the store to receive coupons, ads, and other promotions.” The software application then monitors for the receipt of a data packet from a data packet generator. If one is received, the software application attempts to locate content associated with a code contained in the data packet. If such content is located, the content is then displayed by promotions screen 726. Several examples are shown as screens 730, 732, 734, 736, and 738.

Screen 730 is displayed, for example, when the mobile computing device approaches the toy section of the retail store. The screen 730 indicates that toy buddy packs are currently on sale for $14.99 each, and a thumbnail image of the toy is displayed. Selectable controls are included in screen 730. A details control can be selected by the consumer to request more information. A grab coupon control is provided to grab the coupon for later use, such as during checkout. Even if the coupon is not grabbed by the user, the coupon typically should be stored for later use to avoid frustration if the user later changes their mind and decides they do want the coupon, but then can't get it to trigger through the push system.

Another example is shown in screen 732, which is displayed when the consumer passes the pasta in the grocery section of the retail store. In this example, screen 732 displays a coupon indicating that 16 oz. pasta packages are on sale for 75¢ off. Selectable controls are provided to request more information or to grab the coupon for later use.

Another example is shown in screen 734, which is displayed when the consumer passes by the televisions in the electronics section. Screen 734 indicates that the 32″ LCD HDTV is on sale for $429, which is $20 off the regular price. Selectable controls are provided to request more information or to have the item purchased and sent to the consumers home address.

A further example is shown in screen 736, which is displayed when the consumer passes by the digital movies section. In this example, screen 736 displays information about a movie that is available for purchase, along with a thumbnail image of the movie cover. Screen 736 asks the consumer whether the consumer would like to view a trailer for the movie. If so, screen 736 displays the movie trailer. Alternatively, in another possible embodiment the movie trailer is displayed on an interactive sign located nearby. In this example, the software application sends a request to the store server, which processes the request. The store server then sends an instruction to a computer associated with the interactive sign in the retail site to cause the computer to display the trailer on the interactive sign. The process appears that the mobile computing device is communicating directly with the interactive sign, when it is actually communicating with the store server, which in turn communicates with the interactive sign. Again, this feature can be powerful when combined with groups of people, and can be used to create location-based ad hoc systems having features that are similar to the system currently offered by Groupon, Inc. of Chicago, Ill.

Another example is illustrated in screen 738, which is another coupon for a product in the grocery section. In this example, screen 738 is not displayed when the mobile computing device passes by the tomato sauce. Rather, the coupon shown in screen 738 is displayed immediately after the consumer selects the Grab Coupon control in screen 732. This illustrates how the knowledge of one event can be used to provide additional content that may be of interest to a consumer. In this case, the system noticed that the user had collected a coupon for pasta, and was therefore likely to purchase the pasta. In addition, it may also be known that a consumer that purchases pasta is very likely to also be interested in purchasing pasta sauce to go with the pasta. As a result, a coupon presented to the user at this time may have an increased probability of being used by the consumer than if the same coupon was presented to a consumer that was not purchasing pasta. Accordingly, a cash value (e.g., paid by a wholesaler to the store for the display of the coupon) associated with the display of the coupon in screen 738 may also be greater than a cash value associated with the display of the coupon in screen 732 or even the coupon in screen 738 absent the prior collection of the pasta.

In this way, the monetization value available to the application owner for content delivery may be impacted by consumer behavior(s) in the store. For example, the value of a video promoting Purple Vikings Football Brats may be worth twice as much to the application owner once a 40 year old male has collected a data packet near potato chips and another data packet near beer on a Sunday morning in October. Therefore, aspects according to the present disclosure can facilitate this real-time monetization. Previous online activities of users already informs other types of offer intelligence, and can be incorporated.

FIG. 8 is a schematic block diagram illustrating an example code 800 generated by a data packet generator 104. In this example, the code includes several code portions, including a first code portion 802, a second code portion 804, a third code portion 806, a fourth code portion 808, and a fifth code portion 810. Other embodiments include other quantities of code portions. A wide variety of concatenations are possible. Almost anything measurable or communicable can be incorporated into a concatenation. In the case of the 802.11 protocols there are currently 32 digits available in the SSID. This means that the 32 digits may need to be used efficiently in order to maximize data transfer. Efficient use of the SSID varies of reach type of use. Other embodiments have more or fewer digits.

Another possible example of a concatenation of 32 digits is as follows. A first set of digits are used to identify the device to a mobile computing device in various commercializations. An example of the first set of digits is two digits. A second set of digits are used to identify the retailer locally to the mobile computing device. An example of the second set of digits is five digits. A third set of digits are used to identify the data packet generating device type to the mobile computing device. An example of the third set of digits is one digit. A fourth set of digits are used as a rolling code, that adjusts once per day. Using base 36, this provides over 100 trillion possible combinations. A null step can be added to delete duplications on the rare occasion that two identical codes get pulled for the same user. An example of the fourth set of digits is nine digits, which when using base 36, provides over 100 trillion possible combinations. A fifth set of digits are used for consumer product goods authentication. An example of the fifth set of digits is five digits. A sixth set of digits are used as a data packet generator timestamp. An example of the sixth set of digits is eight digits used as a timestamp, such as having the format YMDHMMSS (e.g., year, month, date, hour, minute, second). This can be helpful in measuring clock drift remotely, for example. A seventh set of digits is used for device monitoring, and may not be obtainable from the server, because it is populated by the data packet generator based on conditions in the field, such as motion and battery life, variance from room temperature, etc.

In some embodiments, content provided to consumers is based, in part, on the demographics of the consumer or other factors, in addition to location-based data. In some embodiments, statistically significant factors are considered. For example, a coupon for a man's shirt may be more desirable to present to a male, while a coupon for a woman's shirt may be more desirable to present to a female.

In some embodiments, the code is broadcast as a network name. An example of a network name is a service set identifier (SSID), such as conforming to the 802.11 family of wireless communication protocols. In some embodiments, the code 800 includes 32 digits.

In some embodiments the first code portion includes at least one of a system identifier and a retailer identifier. Some embodiments include both a system identifier and a retailer identifier, such as shown in FIG. 8. A system identifier is a series of alphanumeric characters provided at the beginning of the code 800 to identify the code 800 as being generated by a data packet generator 104. An example of the system identifier is the set of characters “DG” that stands for “Data packet Generator.” Other embodiments include other characters, such as an abbreviation of a data packet generator company name, or any other desired characters. In some embodiments, the first portion further includes a retailer identifier. The retailer identifier is a set of characters that identify the retailer that the data packet is being transmitted from. In this example, the retailer identifier is the set of characters “RET1” that stands for “Retailer No. 1”. An example of a first code portion 802 is a series of seven alphanumeric characters.

In some embodiments, the first portion includes a hide code. A hide code is a series of characters that indicate that the SSID should not be displayed in a list of wireless networks by computing devices. An example of the hide code is the set of characters “DG,” although any other hide code can be used. It is preferred that the hide code be a set of characters that are not commonly used in the SSID of a wireless access point. For example, if a mobile computing device has the ability to display a list of available wireless networks, the list may include the SSID for the network. Because, in most embodiments, a data packet generator does not permit a computing device to join a wireless network associated with the SSID (further, in some embodiments there is no such wireless network associated with the SSID), the hide code can be useful to avoid displaying the SSID on the mobile computing device, or other computing device. The mobile computing device is then programmed to check the first portion of the code, and if the hide code is present in the SSID, the mobile computing device is programmed to exclude the SSID from the list of available wireless networks.

The second code portion 804 is, for example, a device identifier. The device identifier is a set of characters that identifies the device that transmits the code 800. In this way the device identifier acts like a device serial number. However, in some embodiments the device identifier changes periodically, such as every three months, or every six months, etc. As discussed herein, the changing of the device identifier is useful to prevent mapping of the data packet generators by third parties, and for other reasons. An example of a second code portion 804 is a series of seven alphanumeric characters.

The third code portion 806 is, for example, a token code that provides a unique combination of characters that can be used to identify the particular code 800. For example, a single data packet generator may use codes 800 having the same first portion and the same second portion for a period of time, such as six months. During that time, however, many different codes 800 can be generated at different times. To allow for this, the third portion may change periodically, such as every 3, 5, 10, 15, or 60 seconds (or other intervals of time). In some embodiments the third code is a time code, because the third portion 806 can be used to identify a time that the code 800 was generated. An example of a third portion 806 is a series of seven alphanumeric characters.

In some embodiments the first, second, and third code portions 802, 804, and 806 of code 800 are collectively referred to as a base code 812 of code 800. The base code 812 is a unique code that can be distinguished from other base portions of other codes generated by other data packet generators, and also from other base portions generated by the same data packet generator.

The fourth code portion 808 is, for example, a validation code. The validation code can be used, as discussed in more detail herein, to verify that the code 800 was received by a mobile computing device, such as to present content to a consumer. An example of a fourth portion is a series of seven alphanumeric characters.

A fifth code portion 810 is, for example, a status code. The status code is used by the data packet generator 104 to send information regarding the status of the data packet generator. An example of a status code is a series of four alphanumeric characters. For example, a first character of the status code can indicate a battery status (e.g., 0=OK, 1=low battery). Another character of the status code can indicate whether the data packet generator has been moved. For example, in some embodiments data packet generators are installed in fixed locations and should not be moved except by an authorized technician. If movement is detected by the data packet generator (using an accelerometer, for example), the data packet generator can indicate that movement has been detected in the status code. In some embodiments, bumps and vibrations, such as caused by cart traffic or occasional bumps from consumers is filtered out and is not considered movement. In some embodiments, the accelerometer is checked periodically, such as every 15 seconds. In some embodiments, multiple consecutive checks of the accelerometer must indicate movement before movement is registered. Any other desired status information can similarly be communicated through the status code. Many different messages can be communicated using different arrangements of characters. One example of the fifth portion is a series of four alphanumeric characters.

Because not all codes that are transmitted from a data packet generator are received by a mobile computing device (a mobile computing device will not be in the vicinity at all times), there will be a delay between the time when an event reflected in the status code occurs, and the time that status code is received at the data packet generator server 116. It is noted, however, that the delay decreases as the number of mobile computing devices in the retail site increases. Therefore, the more the system is used and promoted by a retail store, the closer to real-time monitoring of the data packet generators the system obtains. However, some embodiments include other techniques for monitoring the statuses of the data packet generators, such as by permitting direct communication between data packet generators and network 114.

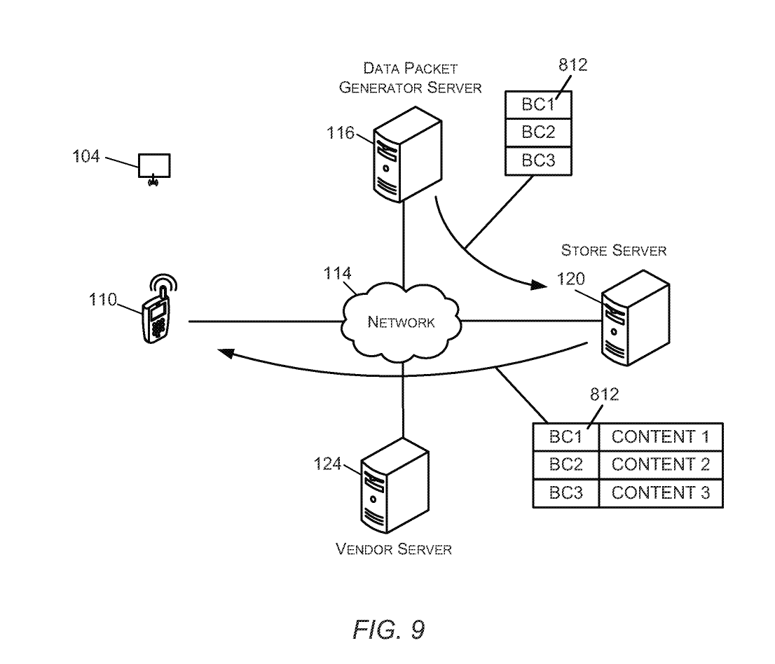

FIGS. 9-12 illustrate an example method of presenting content to a consumer, and further illustrate an example method of providing a marketplace for the content. FIGS. 9-12 illustrate an example system 900 including a data packet generator server 116, a store server 120, a vendor server 124, a data packet generator 104, and a mobile computing device 110. In some embodiments, servers 116, 120, and 124 communicate across a communication network 114, such as the Internet.

FIG. 9 illustrates several exemplary operations between the data packet generator server 116, store server 120, and mobile computing device 110. The data packet generator server 116 provides to store server 120 information that permits store server to identify codes that will be generated by the store's data packet generators 104. In one embodiment, the actual codes are provided, while in another embodiment formulas or algorithms for providing the codes are provided. The codes can be provided through network 114, or by other methods, such as by physical delivery of the data on a computer-readable medium. In this example, the codes include only the base code 812 portions of the complete code 800, shown in FIG. 8.

In some embodiments, a pre-load of content is initiated when the mobile computing device 110 enters the retail site. In this example, the store server 120 identifies the codes that may be generated over the next period of time, such as two hours, and identifies the content that should be delivered to the user if the mobile computing device 110 detects the codes. The base codes and content is then delivered to the mobile computing device 110. In some embodiments the transfer occurs across a local area network or other data communication path (e.g., USB, Bluetooth, etc.).

Some embodiments do not perform the pre-load of content. In this embodiment, the transfer of the base codes and content from store server 120 to mobile computing device 110 may not occur at this time.

In some embodiments, the content is provided by or requested by a vendor. Many different vendors may be interacting with the system at once, and in some embodiments the retail store or others maintain an ongoing action or bidding system for receiving bids from vendors to provide content to consumers. In some embodiments the vendor placing the highest bid is allowed to submit or define content to be provided to the consumer for a given base code 812. In some embodiments, the store sets a reserve price for some or all of the codes. If the reserve price is not met by the bids, the store either provides its own content or no content, instead of displaying content from a vendor.

In some embodiments, the store or building owner sells rights to define the content that will be provided to consumers. In some embodiments, the rights are sold in bundles, such as 1,000 or 10,000, etc. As one example, each unit sold gives the purchaser a right to provide one item of content to a single consumer (through the mobile application operating on the consumer's mobile computing device) based on receipt of a code. In some embodiments the rights are associated with particular consumer demographics or other information known about the consumers. In some embodiments, the sale and purchase of the rights is performed through an electronic trading platform or exchange, similar to a stock (or futures) exchange.

In some embodiments, multiple codes are associated with a single content element. For example, content 1 can be associated with 16, 32, or another quantity of base codes. The content (content 1) is released upon receipt of any of the base codes by the mobile computing device. The base codes may be, for example, a set of base codes to be generated by a single data packet generator, or a set of codes to be generated by multiple different data packet generators in the same store, or a set of codes to be generated by multiple different data packet generators distributed about different stores. To illustrate the latter case, the content 1 is a coupon for a cereal provided by a cereal manufacturer. The cereal is available in many different stores in a city that the consumer may visit. Accordingly, codes associated with data packet generators at all of the stores can be transmitted to the mobile computing device to permit the content to be released regardless of what store the consumer chooses to visit. In some embodiments, the content and codes are stored in memory of the mobile computing device that is available to multiple different retail store applications running on the mobile computing device. In some embodiments, codes and content are associated with an expiration time and are deleted from memory once they have expired. In some embodiments, this process facilitates content delivery on behalf of the manufacturer regardless of which store the mobile computing device user visits. At the same time, the retail store can be rewarded via the monetization mechanism described herein.

All of the servers and computing devices described herein can alternatively be multiple servers or multiple computing devices. In addition, multiple servers or computing devices can alternatively be combined into a single server or computing device.

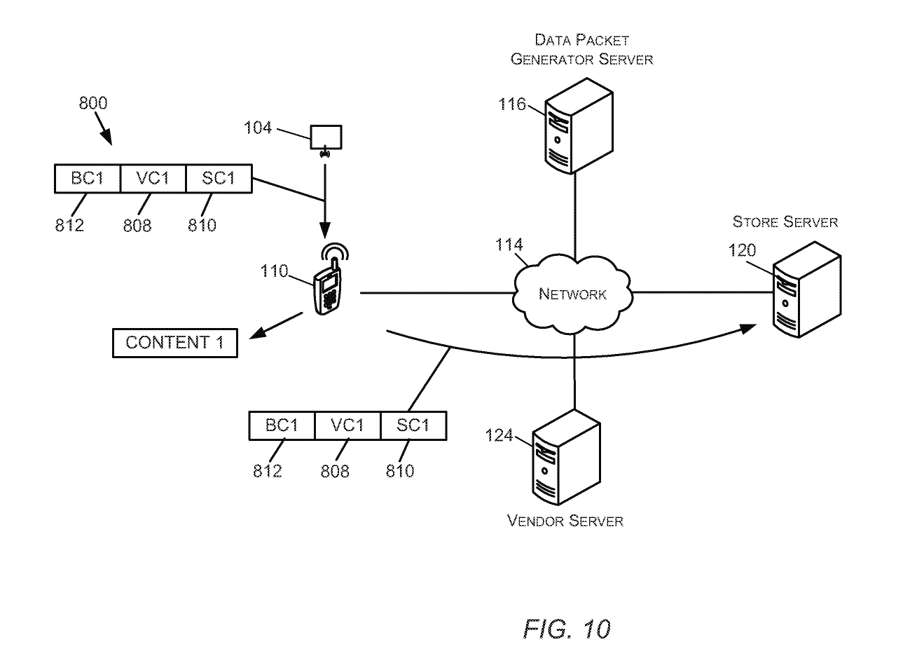

FIG. 10 illustrates several exemplary operations between data packet generator 104, mobile computing device 110, and store server 120, which may occur after performing the operations shown in FIG. 9.

In this example, the mobile computing device 110 comes within the transmission range of data packet generator 104. The data packet generator 104 transmits a code (e.g., code 800, shown in FIG. 8) to the mobile computing device 110. In some embodiments, the code is transmitted as a network name, such as an SSID. The code includes, for example, the base code 812, a validation code 808, and a status code 810.

In some embodiments, upon receipt of the code 800, the mobile computing device compares the base code 812 with the base code previously received from the server 120. If the base codes match, the code is determined to be a valid code and further action can be taken. If the base code is associated with content, such as Content 1, the content is displayed or otherwise made available to the consumer. If the base code is not associated with content, the code can be used for other purposes, such as for incrementing a point score in the store rewards program. The code 800 is then transferred to store server 120.

In another possible embodiment, content is not previously loaded onto mobile computing device 110. In this example, the code 800 can be transferred to store server 120 prior to displaying content or taking other action. The store server compares the base code 812 with the base code from data packet generator server 116 and confirms a match. The content is then transferred from store server 120 to mobile computing device 110, where it is made available to the consumer.

Because data packet generator server 116 only provided the base code 812 to the store server 120 (as shown in FIG. 9), the only way that the store server 120 can obtain the validation code 808, in some embodiments, is by receiving it from mobile computing device 110 after receipt from data packet generator 104.

In some embodiments, the communication between the mobile computing device 110 and server 120 includes further details, such as whether a coupon of Content 1 was collected when it was displayed, and whether the coupon was used to purchase an item, etc.

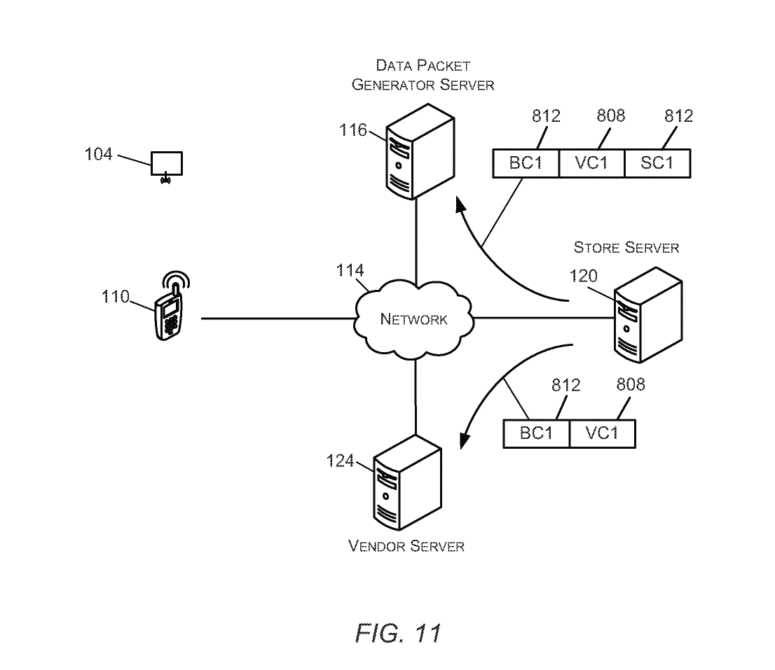

FIG. 11 illustrates several exemplary operations between store server 120, data packet generator server 116, and vendor server 124, such as after the operations shown and described with reference to FIG. 10.

After store server 120 has received code 800 from mobile computing device 110, store server 120 can provide the complete code 800 to data packet generator server 116. Alternatively, only a portion of code 800 is provided, such as the base code 812 and status code 810. The status code 810 information is then used by data packet generator server to monitor the status of data packet generator 104. In some embodiments, the data packet generator server 116 reviews the complete code 800 to confirm the validity of the code, such as to monitor for tampering or other potential interference with the system.

One of the operations that data packet generator server 116 can perform, is to evaluate statistics associated with codes and the timing of the codes, such as to detect tampering. For example, the data packet generator server 116 can monitor the rate at which codes are collected by mobile computing devices in the retail site (e.g., a number of codes collected over a period of time). The rate can be monitored over time to detect abnormalities. For example, if the data packet generator server 116 notices that there is a change in the rate each time a code changes, and then after a period of time the rate returns to the prior level, the temporary decrease could indicate that tampering is occurring.

In addition, in some embodiments store server 120 sends portions of code 800 to vendor server 124. In this example, the portions include base code 812 and validation code 808. In some embodiments, the message also includes an amount of money that is owed by the vendor to the store based on the transaction. The transaction may be based on the display of content, the collection of the content by the user, or the purchase of an item identified in the content. Other embodiments include other types of transactions. Of course, a group of transactions can be combined into a single invoice, if desired. The invoice may be presented periodically, such as once per month.

As noted above, the validation code 808 provided by store server 120 to vendor server 124 verifies that the code 800 was collected by a mobile computing device 110 and forwarded to server 120, because store server 120 is not provided the validation code 808 in advance. Therefore, when the store server 120 provides the base code 812 and validation code 808 to vendor server 124, the store server 120 proves that it is entitled to payment for displaying content to the consumer as requested by vendor server 124.

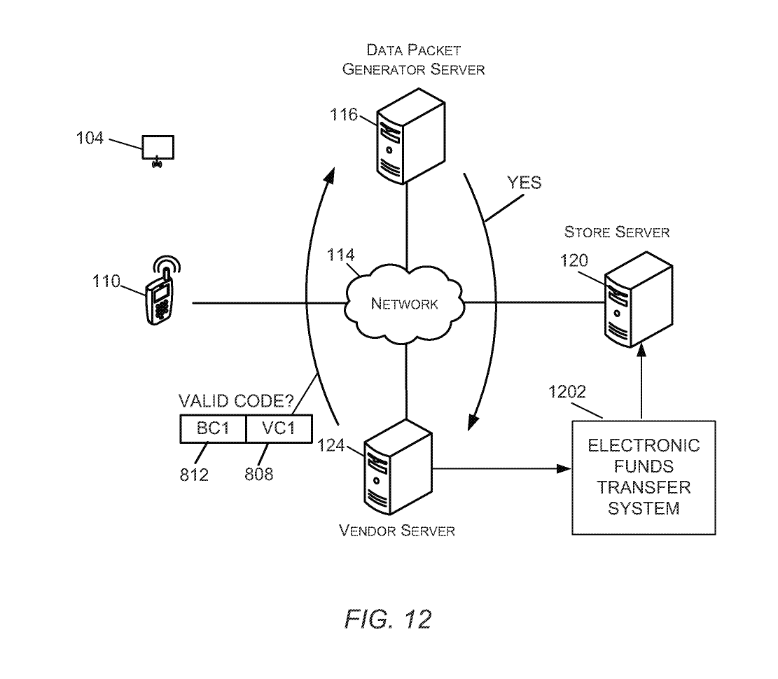

FIG. 12 illustrates exemplary operations performed between vendor server 124, data packet generator server 116, store server 120, and an electronic funds transfer system 1202, such as after the operations shown in FIG. 11.

After vendor server 124 has received the base code 812 and validation code 808 from store server 120, the vendor server 124 communicates with data packet generator server 116 to further validate the transaction. The validate code request includes the base code 812 and the validation code 808. The data packet generator server 116 evaluates the base code 812 and the validation code 808 and determines whether they are valid codes that were generated by data packet generator 104. If so, the data packet generator server 116 responds to vendor server 124 to confirm that the codes are valid. It is also possible that the vendor has its own partial version of data packet generator server 116 and that the vendor server 124 only occasionally or periodically verifies validation code(s) 808 with the full data packet generator server 116.

Upon confirmation by data packet generator server 116, vendor server 124 determines that the amount requested by store server 120 is owed to the store, and therefore an electronic funds transfer, through electronic funds transfer system 1202 is initiated. Although the transfer is schematically illustrated as going between vendor server 124 and store server 120, the transaction may occur separate from these servers, but occur between the vendor and the retail store. In some embodiments the electronic funds transfer system 1202 involves one or more banks.

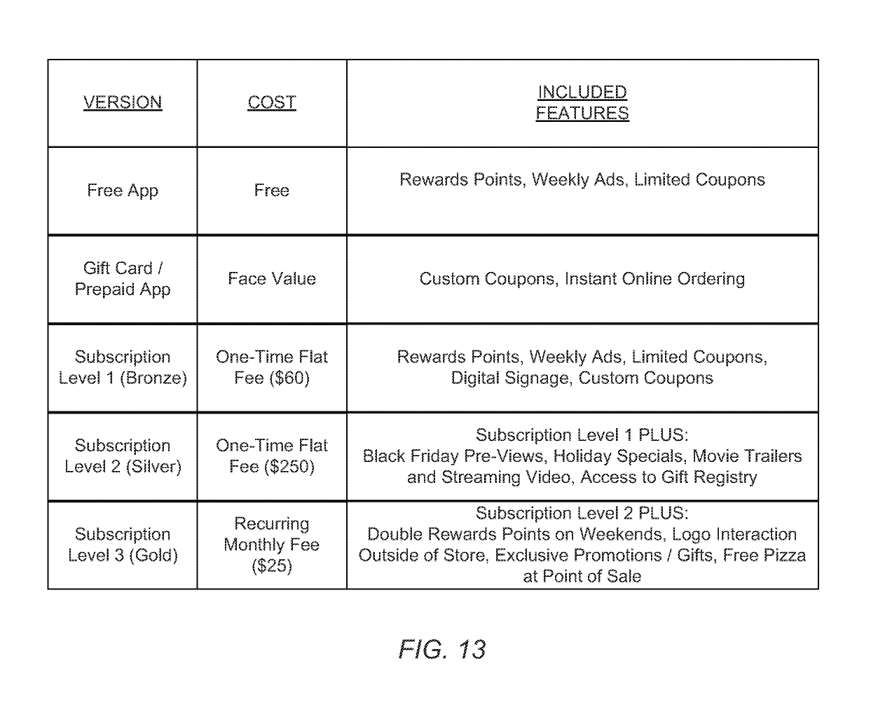

FIG. 13 is a chart illustrating a variety of exemplary software applications available for a consumer's mobile computing device. In this example, the software application come in a variety of different versions, including a free app, a gift card/prepaid app, a subscription level 1 app, a subscription level 2 app, and a subscription level 3 app.

Each application is available for different costs. At least one version of the application is made available for free to encourage consumers to try it out without having to pay money for it. The gift card application is available for a flat fee according to a “face value” of the gift card app. In other words, a $20 gift card application may cost $20. A variety of different subscription levels may also be available, such as the three subscription levels shown. Each subscription level is available for different amounts of money, such as a one-time flat fee of $60, a one-time flat fee of $250, and a recurring monthly fee of $25.

Each version of the software application provides the consumer with access to different sets of features. For example, the free application provides access to the rewards program, weekly ads, and limited coupons.

A gift card/prepaid application version is provided in some embodiments, which includes features such as custom coupons and instant online ordering. An example of a custom coupon is a coupon that is presented to the consumer as the consumer moves through a retail store, as described herein. Instant online ordering is, for example, the ability to make a purchase from the store through the mobile computing device. In one example, the user uses the mobile computing device to take a picture of a products barcode (such as a QR code). The system identifies the product and displays information about the product to the consumer, including a price to purchase it now. If the consumer wants to purchase the product, the consumer selects a button to purchase the product. If the consumer is currently one of the store's retail sites, the consumer can take the product from the shelf, if available, and proceed through the checkout. If the consumer is not in one of the store's retail sites, such as at a competitor's site, or elsewhere, the product can then be shipped directly to the consumer's location. The amount of the purchase is deducted from the gift card app. In some embodiments a gift card app can be purchased by one person, and used by another person. This system can also integrate with gift card management systems, like Swagg.

In some embodiments, a gift card application stops operating once the face value has been depleted. In some embodiments a periodic maintenance fee is charged for the gift card application. In some embodiments, a depleted gift card app has the same features as the free app

A subscription level 1 version provides all of the features of the free application, and also additional features, such as digital signage, and custom coupons.

A next subscription level version (level 2) provides the features of the level 1 version, and further includes black Friday previews, holiday specials, movie trailers, streaming video, and access to store's gift registry through the mobile computing device.

A subscription level 3 version includes all of the features of the level 2 version, and further includes double rewards points on weekends, logo interaction outside of the store, exclusive promotions and gifts, and free pizza at checkout. Logo interaction outside of the store permits a consumer to obtain content from the store even when not located within the store's retail site. For example, the retail store may place an advertisement in a light rail train, at a bus stop, on the outside of a building, or elsewhere. A data packet generator is also placed at that location. When the user approaches the location, this version of the software application operating on the mobile computing device receives a data packet from the data packet generator and provides content to the consumer and/or allows loyalty rewards points to be accumulated. This allows the retail store to interact with consumers even outside of the boundaries of the stores' retail sites.

The software application versions shown in FIG. 13 are provided by way of example only. Other embodiments include different versions, costs, and/or features. As described in U.S. Ser. No. 12/544,798, U.S. Publication No. 2010/0046553, titled Data Packet Generator For Generating Passcodes, filed on Aug. 20, 2009, social networking software applications such as Facebook can integrate into this location system. Examples of social networking software applications include those provided by Facebook Inc. of Palo Alto, Calif.; Apple Inc. of Cupertino, Calif.; Google Inc. of Mountain View, Calif.; and Foursquare Labs Inc., among others.

As discussed elsewhere herein, in some embodiments the software versions are also associated with credit cards. For example, the credit card may have different levels and associated features or rewards that are also obtained with the software application.

Some embodiments include content that is not associated with a particular product in a retail store. For example, when a user is in a sports stadium that is enabled with data packet generators, the content could be an instant replay of an event that has occurred in the game at that time. For example, a screen is displayed that asks it the user would like to view the instant replay. If the user selects “yes,” a streaming video of the event is displayed.

Some aspects of the present disclosure can be used to provide a real estate rewards program. For example, at each open house for a given real estate company, at least one data packet generator is located at or around the house. When a consumer comes to the open house with the mobile computing device, the mobile computing device collects a data packet that shows that the consumer was at the open house. Based on that, the consumer can be awarded rewards points. The rewards points can be redeemed for various products, promotions, or other benefits. For example, the rewards can be redeemed for a reduction in the real estate company's commission. In some embodiments, data packet generators are located at or near a real estate signage. When the data packet is received, content relating to the real estate is provided, such as information about the real estate, a streaming video virtual tour of the real estate, etc.

Tokens, codes, and passcodes are sometimes used interchangeably herein. Each can be included in a data packet in some embodiments.

In view of the foregoing, various embodiments are disclosed including the following:

A method of validating the delivery of content on a mobile computing device.

A method of releasing pre-loaded content to a consumer on a mobile computing device upon receipt of a code.

A loyalty rewards program that accumulates reward points for the consumer as the consumer moves through a building, such as a retail store.

Mobile applications having a variety of different subscription levels, the application subscriptions providing different features associated with an indoor positioning system.

Subscription applications that use codes to deliver different levels of service or content, or provide the consumer with deeper discounts, based upon a subscription level. This can include groups of people in the same or similar locations creating joint purchasing power by banding together.

Prepaid mobile applications that have a cash value for the purchase of products from a retail store.

A method of providing content to certain users based upon their location. For example, a stadium can provide premium content (e.g., streaming video of an instant replay) only to users seated in premium seats.

A method of installing data packet generators within a building, and then selling rights to provide content through a mobile application to a third party.

A method for a retail store to interface with consumers outside of the confines of the retail sites, such as at an outdoor location where the retail store's logo appears or even within a competitor's retail store.

An application manager program operating on a mobile computing device that turns on or off mobile applications based on the receipt of codes as described herein.

A mechanism to cause digital signage to change in real-time, having the appearance of a direct connection between the mobile computing device and the signage, but actually based on receipt of a code and a transfer of instructions across a network (such as the Internet) to a computing device in control of the sign. This can include groups of people in the same or similar locations creating joint purchasing power by banding together.

In some embodiments, the mobile application assists a user with navigating in a building (or set of buildings), such as a mall or airport, such as by displaying maps and directions based on the user's current location in the building.

A method of controlling the frequency at which a mobile computing device checks for wireless network names, wherein the frequency is adjusted based on movement detected by an accelerometer associated with the mobile computing device.

Example Use Case Scenario

An exemplary use case scenario will now be described in detail to further explain some of the many possible embodiments according to the present disclosure.

Guest learns about the retailer's app that is now available to be downloaded onto their Smartphone.

Guest downloads the retailer's app and learns about the privacy policies of the system.

Guest chooses between the gift app, free app, paid app, and subscription app, all of which have various features.

Retailer's app has some unique identifying feature, such as a application serial number.

Guest is encouraged to sign up for a loyalty rewards program.

Retailer's database either keeps the app information generic (e.g., if no loyalty rewards program) or makes the app information specific (e.g., if loyalty rewards program is active).

Retailer's database generates a profile for the guest including products they will likely enjoy, the minimum/maximum pace of content delivery for their demographic, etc.

Retailer and consumer packaged goods (CPG) company come to terms on type(s) of content (coupons, ads, information, etc.) as well as the pricing terms of delivery (which could be variable based on in store behavior). Content is pooled at the retailer's database (or made ready at some database). No money is exchanged between the CPG and the retailer OR money is exchanged (depends on whether the retailer wants to “oversell seats” like the airlines do or if they'd rather carry it out in real-time OR some combination. If coupons are to be used, the retailer ensures that the coupons are redeemable. In some embodiments, a retailer planogram is used as one of the filters for choosing content. As a result, there may be one promotion per aisle, or some other reasonable ratio that connects location with content.

Guest is excited to try out their new app so they drive to the retailer's location.

Guest's spouse might have sent him a list of items to pick up, that translate to a route, and possibly trigger a vibrate or alarm near the product in the store.

Guest will have the option (or may have already taken this step) to turn the loyalty rewards program functionality on/off, and to turn digital signage functionality on/off, and to turn content delivery functionality on/off (e.g., in some embodiments the loyalty rewards program points do not accumulate at the same pace, if at all, if the content delivery functionality is turned off). There may be other features that the guest can control, such as whether they'd like to be called by name if they initiate a request for a store associate, etc.

Some embodiments include, for example, three or four levels of privacy to protect consumer data and privacy. To protect our brand, we plan to work as closely as legally possible with the Federal Trade Commission, including their much anticipated “Privacy by Design” initiative expected to be released before year end 2010. At this point we expect that guests who have turned the loyalty rewards program “off” will not have data collected on them. Limited functionality of content delivery will still be provided even without loyalty rewards program turned “on”. In other words, the loyalty rewards program being turned off, but the content delivery being turned on, will still result in generic coupons with delivery intelligence functionally equivalent to (or better than) radio or newspaper ads. This accommodates, for example, those who don't jump into Smartphone usage fully because of data usage concerns. Guests who have turned the loyalty rewards program “on” will have data collected on them that can be analyzed by the app owner, but not yet sold to third parties. In some embodiments, this level of data must be kept in an erasable storage format. Prior to redemption of the loyalty rewards program, the guest has the right to give up their loyalty rewards program points in exchange for the app owner erasing the data. If the guest chooses to redeem their loyalty rewards program points, they are officially selling their data to the retailer (and anyone the retailer may want to sell it to). At all times the guest must know how the data is being used, even after the data has been “sold” through redemption of the loyalty rewards program points. In some embodiments, the system and process conforms to the anticipated “Privacy by Design” initiative of the FTC. For example, the system and process described above is expected to conform to the “Privacy by Design” initiative. Specific changes to the privacy policy described herein are anticipated, while still meeting the intent of carefully guarding user's privacy.

Guest turns on the retailer's app because they saw a sign in the store, or met a greeter, etc.

Retailer's app may prompt the guest to turn the Wi-Fi completely or partially “on”. Note: in some cases this might be automated, and of course in many cases the Wi-Fi will already be “on”.

Retailer's app begins to search periodically for locked SSID(s) with the first seven digits matching the retailer (for example, WP_TGT_). This significant privacy feature allows the retailer's app to make an informed decision locally regarding the probable location of the guest without notifying any outside party (including the data packet generator provider). In some embodiments, in-store location is identified and/or authenticated by standard location-based systems that typically depend on assisted GPS.

Retailer's app identifies at least one SSID that matches the criteria for the store.

Retailer's app prompts the guest to allow or disallow in-store location.

Guest allows in-store location.

Retailer's app may determine that the battery level of the Smartphone won't support the anticipated shopping experience. The guest is notified of this problem and may be prompted to use the charging station near the gift registry section of the retailer's store.

Guest overrides the battery prompt (if any was needed).

Retailer database requests (from the data packet generator server) sufficient tokens to last a certain period of time (e.g., two hours) for that store or mall.

Data packet generator server, also sometimes referred to as the “Where-PRO server” calculates those tokens and fulfills the data request up to the first 21 digits of the 32 digit locked SSID's.

As one example, each retail store is assumed to have a quantity (e.g., 100) of data packet generators that change the codes periodically, such as every 15 minutes. The codes are broadcast every few seconds, for example, based on an optimized ping frequency. A wide variety of token concatenations are possible in the different embodiments. An example of the concatenation of the 32 digit SSID's are as follows:
first seven digits=retailer code, not changing
next seven digits=alpha numeric serial number
next seven digits=retailer rolling code
next seven digits=CPG rolling code
final four digits=passive monitoring system (at least battery and movement tuning out cart traffic).

Content for the guest is merged with the tokens and all tokens and content are downloaded into the app. In some embodiments, this download occurs in advance, such as through a weekly update to the app (with a week's worth of tokens) performed at the user's home, such as after the guest has defined a “home store”. In some embodiments, in-store download of content can be facilitated by limited in-store Wi-Fi and/or a femptocell boost available near the entry of the store (perhaps at or near the charging station). In expensive FM radio chips may soon be included in smart phones in the US and are already included in 1 billion phones globally. It is conceivable that this will someday enable FM radio to be used as the preferred content delivery mechanism (for efficiency sake in taking load off of the network). In the FM radio scenario, if it comes to pass, the only download required by the guest is the tokens that unlock the content that is selected for them. In some embodiment, content includes multiple layers. For example, if someone “accepts” a coupon for strawberries they may be offered a promotion for strawberry vinaigrette down the next aisle.

User decides to put the Smartphone into the a cartdock or user decides to hold the Smartphone and user begins their shopping experience.

Tuning out cart traffic, the accelerometer and/or gyroscope in the Smartphone can be used to adjust the search frequency of the Wi-Fi. For example, if the Smartphone is stationary the Wi-Fi may search for locked SSID's every 5 seconds for 2 seconds. If the Smartphone is moving, the Wi-Fi may search for locked SSID's continuously. This is a battery saving service to the guest.

In some embodiments, the data packet generator is pinging locked SSID's periodically. The ping rate, power level, antenna(s) and casing must together be optimized for each environment. For example: end caps may ping more frequently but at a lower level than a mid-aisle. It is preferred that all of the battery-powered hardware has a similar battery life for battery replacement purposes (e.g., it does no good if one goes six months and another goes nine months, because replacement will need to occur at the earlier date anyway). During optimization, the variables of ping rate and power level can be adjusted to coincide with expected occupancy of the store on both daily and seasonal schedules. For example, an end cap hardware unit may ping twice as frequently in late afternoon as compared to early in the morning.

The app looks for alignment between the tokens that have been downloaded and the first 21 of 32 digits that it “sees” in nearby locked SSID's. If a match is found, the app further considers signal strength to determine whether this should “count” for a loyalty point and/or whether content should be released. In some embodiments, this allows a software side adjustment for releasing content at certain signal strength thresholds. It is entirely possible that an SSID is visible to the Smartphone, but not within content delivery range/threshold. In some embodiments, the software “collects” all 32 digits even though it could only make a match on the first 21.

The user, in one case, simply collects a loyalty rewards program point.

The same, user in another case, gets access to a coupon that they may or may not need to “grab”. Even ungrabbed coupons must be stored in the app somewhere in case the user changes their mind since them returning to the same place may not duplicate the ad delivery that occurred in the first place. The “grab coupon” functionality, or something similar like a thumbs up/down, can be used to assess the guest's pleasure/displeasure in receiving the ad. If a certain threshold of coupons are not “grabbed” then a pricing premium should, in some embodiments, be applied to the retailer/CPG to avoid annoying customers.

The app considers whether it has a sufficient 3G/4G and/or (such as in the case of iPod Touch devices) Wi-Fi access. Some smart phones, such as Apple devices, have more restrictive policies on Wi-Fi access.

The app determines that it has sufficient 3G coverage so it reaches out to the retailer's server and delivers the 2@32 digits that it collected so far. If it didn't have 3G coverage it would have waited until later/stored/accumulated the 32 digit SSID names along with timestamps (which are helpful throughout).

The app furthermore requests any updates to its content, based on any and all available factors.

The Retailer's server decides that it wants to cash in on the CPG ad it delivered in its own store. In some embodiments, such an ad is not the retailer's own ad. The retailer's server sends at least the first 28 digits plus the timestamp of collection to the CPG server. The CPG server requests from the data packet generator server confirmation of the first 28 digits. The data packet generator server “rewinds” to the timestamp (and or reasonable range of the timestamps to cover device drift) and says ‘yes’ or ‘no’ to the CPG. If yes, the CPG pays the agreed upon price for the ad delivery, probably via electronic funds transfer. In some embodiments, the received funds are allocated among any or all interested parties, such as the data packet generator company, the CPG company, the retailer, and the building owner. In some embodiments the retailer and the building owner are the same. For example, a meaningful percentage of this transaction is allocated to the data packet generator company, a meaningful percentage of this transaction is allocated to the retailer (such as to fund the loyalty rewards program. As a more specific example, 3% goes to the data packet generator company and 20% funds the retailer's loyalty rewards program. This permits, for example, the retailers to promote themselves. In some embodiments, the management of the allocations is provided by a single company on behalf of the other companies, such as to assist less sophisticated retailers.

In some embodiments, a marketplace, with features similar to the stock market, is created for real-time price adjustments and buying and selling of ads. In some embodiments, there is a benefit to CPG's who are launching new products to purchase options on future ads so that they can hedge their risk in any new product offering or collection of product offerings. Buying these upfront can provide the app owner with more money up front, which can then be used for a variety of purposes.

In some embodiments, integrity testing of the system is provided. Integrity testing includes, for example, secret shoppers, video comparisons, etc. and can supplement the other safeguards. Integrity testing may involve, for example, confirming that not only was the code collected, but also that the content was delivered.

In some embodiments, lift (e.g., the impact that a promotion has on sales) is evaluated. A variety of mechanisms for evaluating, measuring, and comparing lift can be used, including info at the point of sale (POS).

In some embodiments, monitoring for spikes in SSID collection within the first minute after a token has changed is another way to safeguard the system. Noticeable patterns of SSID spikes may indicate that the retailer is redistributing the discovered CPG code. If this gets to be a problem then the CPG code may need to turn more frequently than the retailer code.

The retailer's server also sends all 32 digits (or at least the first 21 plus the last four) of both SSID names to the data packet generator server. This allows the data packet generator server to analyze the last four digits and monitor the system passively. In some embodiments, if a device is determined to have moved (as measured by e.g., two 15 second subsequent accelerometer readings that display movement exceeding cart traffic) then the retailer's server is contacted by the data packet generator server (with request for location update) and the serial number of that data packet generator hardware needs to be noted and until the retailer updates the location and notifies the data packet generator company. In some embodiments, downtime gets increasingly progressively expensive for the retailer over time so that all have an incentive to keep the system integrity in place.

In some embodiments, data is sent using secure communications. For example, data encryption is used in some embodiments.

If a 3G connection is available then the guest Smartphone may display a “call for assistance” button. This may appear and disappear based on the connection. Wi-Fi access points may someday replace or supplement the guest assistance phones available in some stores.

Guest decides to return to an area where they ignored a previous coupon. This is known because the app collected the first of eight tokens, then the third of eight tokens, and then the fifth of eight tokens in a list. The guest is able to pull up the old coupon, but also, low and behold, a different promotion may be sent, possibly for a competing product, because the user appears to be waffling on a purchasing decision.

Guest either doesn't notice the hardware, or the hardware seems to “fit” in the mind of the guest.

In some embodiments, hardware is designed to accommodate installations and service, especially battery replacement if rechargeable batteries are used.

Guest gets near a digital sign and the sign reflects the guest's perceived area of interest in that space.

Guest Smartphone interacts with hardware in various store environments including end caps, mid aisle, open areas, grocery areas, POS areas, etc.

There may be permanent and temporary hardware available. CPG hardware may be temporary. Retailer hardware may be more “permanent”. The CPG hardware may be accessible within the retailer's app as well as form the CPG's app. The CPG hardware may link not to a planogram but to a product. The CPG may be responsible for placement. The battery on the CPG may last not as long (temporary). Example, the CPG may have 20,000 hardware units distributed throughout the world but all of those are running a common algorithm. This allows the CPG to get to customers in all levels of retail (from sophisticated retailers down to smaller or less-sophisticated retailers).

In some embodiments, the retailer and CPG may want to coordinate on the loyalty rewards program point redemption so that overstock from the CPG is made available for loyalty rewards program points redemption.

Guest decides to exit store and go down the street to a small grocery store. The Smartphone OS or a master app turns “on” and “off” various CPG apps since the small grocery store may not yet have their own app. The various CPG apps might even have been able to access this info in the retailer's place of business, but this is a business decision as to what's best (CPG's on/off or retailer's on). In some embodiments, the appropriate questions to ask are “who controls the real estate?” and “how do the guest incentives work?” Another appropriate question to ask is “whose app?”

Loyalty rewards program points in the light rail train, bus stop, stadium, etc. are collected by the guest's Smartphone. Anywhere the retailer's brand shows up is a possible place of brand interaction.

In some embodiments, at POS the guest may be encouraged to buy a pizza and then go over (past POS) to pick up the pizza (to avoid two swipes for the home book keeper).

In some embodiments, the guest makes purchases at the POS from the Smartphone. Tokens collected near POS may authenticate that a purchase took place from a particular location and transactions above a certain threshold or type may be stopped if this secondary location information isn't accompanying the payment.

In some embodiments, the guest's app is linked to a credit card, or is an extension of a credit-card like system (for example gold, silver, platinum, etc). This gets back to gift, free, paid, subscription, etc. The discounts and contents for each may vary.

All data and tokens get back to the server for analysis as soon as available, which might mean real-time if a connection is available.

In some embodiments, the POS includes incentives to encourage the guest to return again soon.

Vehicle Sales

In some embodiments, token generators are installed in vehicles that are for sale which may include cars, trucks, RVs, motorcycles, boats, yachts, airplanes, etc. This allows new and used vehicle sales to occur in a manner that creates far less pressure on potential customers than traditional vehicle salesmen have been known to create. This also allows the content/message to be controlled by the dealer and/or manufacturer, such as through a hosted video describing the features and benefits of that particular vehicle. Desired content may be preloaded, but even if it is streamed in real-time the content is accessed once an application running on the customer's (or dealer's) mobile computing device recognizes the correct token. In some embodiments, if the signal strength exceeds one or more thresholds (each of which can release unique content) the mobile computing device displays the content. Some information or content may come from the manufacturer and some may be customized by the dealer. In some embodiments the application recognizes when the vehicle is in motion (such as through assisted GPS or motion sensors) and adjusts or adjourns the message for improved safety. In some embodiments the VIN number of the vehicle is also all or part of the serial number of the token generator.

In some embodiments the serial number of the token generator is easy to find and read from a short distance (which may include an RFID reader) so that the vehicle sales manager can more easily ensure that token generators are assigned to the correct vehicles. In the case of used cars, statistics collected/accumulated on the car during its years in services can be incorporated into the information delivered. When the application collects all digits in the token (even those digits that may not have been initially supplied via server access to the content delivery provider/app manager) the verification of delivery can occur (as discussed herein) when the vehicle sales company confirms that ALL tokens match those expected by the token generating server. In some embodiments the hardware plugs into the 12V cigarette lighter found in most vehicles. This 12V use may minimize manufacturing costs while improving performance, such as during very cold conditions. In some embodiments the potential customer's information is used to run various statistics and analysis such as how long the person was in the vehicle, which vehicles were looked at most closely, etc. In some embodiments, once a sale of a vehicle has occurred, the used hardware is sent to a manufacturer for reuse.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A method of validating a presentation of promotional content to a consumer, the method comprising:
receiving a code at a server computing device from a mobile computing device, wherein receipt of the code indicates that promotional content has been presented to the consumer, the code including at least a validation code;
requesting payment from a third party to compensate for presentation of the promotional content to the user; and
providing the validation code as evidence that the promotional content has been presented.

2. The method of claim 1, further comprising:
wirelessly transmitting the code to the mobile computing device with a data packet generator located within a retail store, the code being encoded in the wireless transmission's service set identifier as wireless local area network name according to an IEEE 802.11 protocol.

3. The method of claim 2, further comprising:
determining that the code is associated with the promotional content; and
presenting the promotional content to the consumer with the mobile computing device after receipt of the code.

4. The method of claim 1, wherein the code further includes a base code and a status code, the base code including data that identifies the data packet generator that wirelessly transmitted the code, the status code providing data that identifies at least one status of the data packet generator.

5. The method of claim 1, wherein requesting payment comprises providing the validation code to a second server computing device.

6. The method of claim 1, further comprising receiving a payment from the third party for presentation of the promotional content after requesting payment.

7. The method of claim 1, further comprising:
receiving the validation code at a second computing device, the validation code being provided to the second computing device on behalf of the third party;
evaluating the validation code with the second computing device; and
sending a message from the second computing device confirming that the validation code is valid.

8. A method of releasing content on a mobile computing device upon the occurrence of an event, the method comprising:
transferring content to a mobile computing device;
transferring a first code to a mobile computing device, the first code being associated with the content;
wirelessly receiving a second code with the mobile computing device;
comparing at least part of the first code with at least part of the second code, and
presenting the content on the mobile computing device after comparing and having found a match between at least part of the first and second codes.

9. The method of claim 8, wherein wirelessly receiving a second code occurs within a retail store.

10. The method of claim 9, wherein the content is promotional content associated with a product, wherein receipt of the second code indicates that the mobile computing device is near the product.

11. The method of claim 8, wherein transferring the content to the mobile computing device occurs after receipt of the second code.

12. The method of claim 8, presenting the content on the mobile computing device comprises prompting the consumer regarding interaction with an interactive sign, the interactive sign being a display device separate from the mobile computing device.

13. The method of claim 8, wherein wirelessly receiving the second code with the mobile computing device comprises receiving an service set identifier identifying a network name, wherein the network name includes the second code.

14. The method of claim 8, further comprising sending at least part of the second code to a server computing device after presenting the content on the mobile computing device.

15. The method of claim 8, wherein the content includes information relating to at least one of a coupon, a promotion, or an incentive.

16. A method of managing a consumer loyalty rewards program, the method comprising:
enrolling a consumer into a loyalty rewards program for at least one store;
receiving data at a server computing device from the consumer's mobile computing device, the data related to movement of the consumer within at least one of the stores; and
awarding points in the loyalty rewards program based at least in part upon the data.

17. The method of claim 16, wherein the data includes codes wirelessly received by the consumer's mobile computing device as the mobile computing device was moved through the store, and wherein awarding points comprises awarding points based at least in part upon the codes.

18. The method of claim 16, wherein the points are awarded based on an estimate of a distance that the mobile computing device moved through the store.

19. The method of claim 16, further comprising providing a product to the consumer at a reduced price as a reward for accumulating the points in the loyalty rewards program.

20. The method of claim 16, wherein the data received with the mobile computing device is received as a service set identifier in a wireless transmission.
